(19) United States
(12) Patent Application Publication
(10) Pub. No.: US 2021/0292537 A1
(43) Pub. Date: Sep. 23, 2021

(54) CURABLE COMPOSITION, PRESSURE-SENSITIVE ADHESIVE, ADHESIVE TAPE, AND ADHESIVE PRODUCT

(71) Applicant: 3M INNOVATIVE PROPERTIES COMPANY, St. Paul, MN (US)

(72) Inventor: Wenjie Zhang, Shanghai (CN)

(21) Appl. No.: 17/262,423

(22) PCT Filed: Jul. 18, 2019
(86) PCT No.: PCT/IB2019/056156

§ 371 Date: Jan. 22, 2021

(30) Foreign Application Priority Data
Jul. 23, 2018 (CN) 201810812727.8

(51) Int. Cl. C08L 51/00; C09J 133/08; C09J 4/06; C09J 7/38

(52) U.S. Cl. CPC C08L 51/003; C09J 133/08; C09J 4/06; C09J 2469/006; C09J 2433/00; C09J 2301/302; C09J 7/385

(57) ABSTRACT

The present invention provides a curable composition, a pressure-sensitive adhesive, an adhesive tape, and an adhesive product. The present invention belongs to the technical field of acrylate pressure-sensitive adhesives. The pressure-sensitive adhesive formed of the curable composition of the present invention has good high-temperature and high-humidity repulsion resistance. The curable composition comprises: a monomer component, comprising at least two polymerizable monomers, wherein the polymerizable monomers comprise a non-tertiary alcohol (meth)acrylate monomer, and an acid-functional non-ester unsaturated monomer having at least one olefinic bond; a (meth)acrylate polymer tackifying resin having a specific molecular weight and a glass transition temperature; a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.; a cross-linking agent component, comprising an isocyanate cross-linking agent and at least one non-isocyanate cross-linking agent.

### TECHNICAL FIELD

The present invention belongs to the technical field of acrylate pressure-sensitive adhesive, and more particularly, to a curable composition, a pressure-sensitive adhesive, an adhesive tape, and an adhesive product.

### BACKGROUND

Pressure-sensitive adhesives (PSA) are adhesives sensitive to pressure. Without the application of other means such as a solvent or heat, PSAs can form a firm bond with the adherend simply through the application of light pressure with a finger. Acrylate-based pressure-sensitive adhesive is currently the most widely used PSA. Acrylate pressure-sensitive adhesive has features such as good weatherability, high performance-price ratio, good transparency, high cohesive strength, high bonding power, and a broad application range.

Acrylate pressure-sensitive adhesives are frequently used in consumer electronics. For example, acrylate pressure-sensitive adhesives may be used in mobile terminals (mobile phones), tablets, notebooks, and the like, to bond a display screen (display panel) or a flexible wiring board with a support frame. Due to factors such as processing imprecision and deformation, the support frame may, due to deformation forces, come off from the display screen after being bonded. The display screen would thus protrude from the outer shell, which is a defect commonly called “screen popping out.” For the reasons above, acrylate pressure-sensitive adhesives ought to be able to resist the above peeling force; in other words, it should possess “repulsion resistance.” In particular, during the shipping process, consumer electronics are often kept in high-temperature and high-humidity environments for hours, or even tens of hours. Thus, it is vital that the adopted acrylate pressure-sensitive adhesives possess high-temperature and high-humidity repulsion resistance.

However, existing acrylate pressure-sensitive adhesives are still unable to meet the requirements of repulsion resistance in high-temperature, high-humidity environments, especially at a temperature of 85° C. and a relative humidity of 85%.

### SUMMARY

One objective of the present invention is to provide a curable composition which, after curing, forms into a pressure-sensitive adhesive having excellent high-temperature and high-humidity repulsion resistance.

The curable composition of the present invention comprises:

a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

Preferably, the isocyanate cross-linking agent is a non-blocked isocyanate cross-linking agent.

Preferably, the non-isocyanate cross-linking agent is a non-thermosensitive non-isocyanate cross-linking agent.

Preferably, the non-isocyanate cross-linking agent comprises one or more of triazine cross-linking agents, multifunctional (meth)acrylate cross-linking agents, benzophenone cross-linking agents, and copolymerizable aromatic ketone cross-linking agents.

Preferably, the non-(meth)acrylate polymer tackifying resin component comprises at least two tackifying resins respectively selected from the following different types of resins: hydrogenated rosin resin-type tackifying resins, hydrogenated terpene phenolic resin-type tackifying resins, and hydrocarbon resin-type tackifying resins.

Preferably, the (meth)acrylate polymer tackifying resin is formed via copolymerization of raw materials comprising at least two polymerizable monomers, wherein the polymerizable monomers comprise non-tertiary alcohol (meth)acrylate monomers, and acid-functional non-ester unsaturated monomers having at least one olefinic bond.

Preferably, the curable composition further comprises:

a photoinitiator.

Preferably, the curable composition further comprises:

a (meth)acrylate copolymer, formed via copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond; and
the (meth)acrylate copolymer has a weight-average molecular weight of between 500,000 Da and 10,000,000 Da.

Further preferably, a weight ratio of the isocyanate cross-linking agent to a total weight of the monomer component and the polymerizable monomers for forming the (meth)acrylate copolymer is less than or equal to 1.2%; and

a weight ratio of the non-isocyanate cross-linking agent to a total weight of the monomer component and the polymerizable monomers for forming the (meth)acrylate copolymer is less than or equal to 5%.

Further preferably, a weight ratio of the isocyanate cross-linking agent to a total weight of the monomer component and the polymerizable monomers for forming the (meth)acrylate copolymer is between 0.1% and 1.2%; and

a weight ratio of the non-isocyanate cross-linking agent to a total weight of the monomer component and the polymerizable monomers for forming the (meth)acrylate copolymer is between 0.01% and 2%.

Further preferably, a weight ratio of the (meth)acrylate polymer tackifying resin to a total weight of the monomer component and the polymerizable monomers for forming the (meth)acrylate copolymer is between 5% and 18%; and

a weight ratio of the non-(meth)acrylate polymer tackifying resin component to a total weight of the monomer component and the polymerizable monomers for forming the (meth)acrylate copolymer is between 8% and 18%.

Further preferably, a weight ratio of the non-(meth)acrylate polymer tackifying resins, having a softening point greater than or equal to 130° C. in the non-(meth)acrylate polymer tackifying resin component, to a total weight of the monomer component and the polymerizable monomers for forming the (meth)acrylate copolymer is greater than or equal to 6%.

Further preferably, a slurry polymer is formed with the monomer component and the (meth)acrylate copolymer; and

the slurry polymer is formed via partial copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond.

Another objective of the present invention is to provide a pressure-sensitive adhesive prepared from the above curable composition.

The pressure-sensitive adhesive of the present invention is formed by curing a curable composition, wherein the curable composition comprises:

a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

Another objective of the present invention is to provide an adhesive tape prepared from the above curable composition.

The adhesive tape of the present invention comprises a pressure-sensitive adhesive formed by curing a curable composition, wherein the curable composition comprises:

a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

Another objective of the present invention is to provide an adhesive product prepared from the above curable composition.

The adhesive product of the present invention comprises a first member, wherein at least a partial surface of the first member has a pressure-sensitive adhesive bonded thereon; and the pressure-sensitive adhesive is formed by curing a curable composition, wherein the curable composition comprises:

a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

### BRIEF DESCRIPTION OF THE DRAWINGS

FIG. 1 is a schematic illustration showing a sample under test for repulsion resistance in the present invention;

FIG. 2 is a schematic illustration showing the rebound of the sample under test for repulsion resistance in the present invention.

### DETAILED DESCRIPTION

In order to allow a person of skill in the art to better comprehend technical solutions of the present invention, the present invention is further described in detail below in combination with accompanying drawings and particular embodiments.

### Interpretation of Terms

In the present invention, the meanings of the following terms or descriptions are as follows:

The description of “A and/or B” means that any one or both of the two cases may occur, i.e., including “A and B,” “A,” and “B.”

The description of “A to B” or “between A and B” includes values of A and B, and any value greater than A and less than B. For example, “1 to 10” includes 1, 10, and any value greater than 1 and less than 10, e.g., 2, 3, 4, 5, 6, 7, 8, 9, 2.3, 3.5, 5.26, 7.18, 9.999, etc.

The description of “A is essentially B” or “A is about B” denotes that A is, in general, in compliance with the B condition; but a certain difference possibly exists between A and B; and the difference is small on the scale of B.

Unless otherwise specified, “viscosity” referred to in the present invention is measured with an ubbelohde viscometer.

Unless otherwise specified, “molecular weight” referred to in the present invention is a weight-average molecular weight and is measured using the gel permeation chromatography (GPC).

“Glass transition temperature” refers to a temperature at which a transformation between a high-elastomeric state and a glassy state of a polymer takes place. In other words, it is a temperature at which an amorphous portion of the polymer is transformed from a frozen state to a thawed state. Unless otherwise specified, the glass transition temperatures referred to in the present invention are all determined by differential scanning calorimetry (DSC).

The “glass transition temperature of a monomer” refers to the glass transition temperature of a homopolymer of the corresponding monomer.

The “softening point” refers to the temperature at which an amorphous polymer begins to soften. Unless otherwise specified, the softening points referred to in the present invention are all determined by the “Ring and Ball” method.

“Substance amount used,” unless otherwise specified, refers to weights or ratios by weight for the amounts or ratios of the substance amounts used herein.

“Weight percentage of B in A” means that B is a part of A, and refers to the weight percentage of B with the weight of A (including B) being 100%.

“Weight ratio of B to the weight of A” means that B does not belong to A, and refers to the weight percentage of B based on the weight of A with the weight of A (not including B) being 100%.

The description of “(meth)acrylic acid” refers to two situations, i.e., acrylic acid and methacrylic acid.

The description of “(meth)acrylate” refers to two situations, i.e., acrylate and methacrylate, i.e., a generic term of esters of (meth)acrylic acid (acrylic acid and methacrylic acid) and homologues thereof; and specific optional examples include methyl (meth)acrylate, ethyl (meth)acrylate, methyl methacrylate, ethyl methacrylate, and the like.

“Tertiary alcohol” refers to an alcohol in which the other three groups to which the carbon atom is attached where the hydroxyl group is located are all non-hydrogen substituents; and “non-tertiary alcohol” refers to an alcohol that does not belong to the tertiary alcohol.

A “polymer” refers to a substance formed from a polymerization reaction of one or more polymerizable monomers, including homopolymers, copolymers, trimers, and the like.

A “copolymer” refers to a polymer formed via polymerization of at least two different polymerizable monomers, i.e., all polymers other than homopolymers, including random copolymers, block copolymers, graft copolymers, alternating copolymers, mixtures thereof, and the like.

“Partial copolymerization” means that a portion of polymerizable monomers as the raw material have been copolymerized to form copolymers; and at the same time, the other portion of the polymerizable monomers have not yet been copolymerized and are kept in the monomer form.

“Curing” means a process in which a liquid substance is transformed from a liquid state into a solid state with viscoelastic behaviors by means of polymerization and/or cross-linking of components therein.

A “pressure-sensitive adhesive” means a substance that can be bonded to a substrate and meet the following conditions at least at the ambient temperature (5° C. to 40° C.): (1) the substance has a lasting stickiness; (2) bonding can be achieved under the pressure of finger press; (3) the substance changes its shape to be attached to the substrate; and (4) the substance has sufficient cohesive strength to be removed essentially cleanly from the substrate.

An “adhesive tape” means a product in a substantially strip or sheet shape which can be bonded to a substrate or can bond two substrates together.

### Curable Composition

The present invention provides a curable composition which can be cured (preferably by means of UV light) to form a pressure-sensitive adhesive with excellent high-temperature and high-humidity repulsion resistance.

The curable composition of the present invention comprises:

monomer components, comprising at least two polymerizable monomers, wherein the polymerizable monomers comprise a non-tertiary alcohol (meth)acrylate monomers, and an acid-functional non-ester unsaturated monomers having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

The curable composition of the present invention comprises a (meth)acrylate monomer which is a main component for forming an acrylate pressure-sensitive adhesive. Therefore, the pressure-sensitive adhesive formed with the curable composition of the present invention is an acrylate pressure-sensitive adhesive.

The curable composition of the present invention further comprises a (meth)acrylate polymer tackifying resin with a specific weight-average molecular weight (Mw) and a glass transition temperature (Tg). The (meth)acrylate polymer tackifying resin refers to a tackifying resin formed by polymerizing a (meth)acrylate monomer as a major component, which is a substantially completely polymerized polymer.

The curable composition of the present invention further comprises a non-(meth)acrylate polymer tackifying resin component, i.e., it should comprise at least two tackifying resins that are not (meth)acrylate polymers; and in this non-(meth)acrylate polymer tackifying resin component, at least a part of non-(meth)acrylate polymer tackifying resin should have a softening point greater than or equal to 130° C.

The curable composition of the present invention also contains at least two different cross-linking agents, including at least one isocyanate cross-linking agent, and at least one cross-linking agent that is not an isocyanate.

The inventor inventively found that, in a curable composition for forming an acrylate pressure-sensitive adhesive that meets the above requirements, by using both an isocyanate cross-linking agent and at least one other cross-linking agent, the pressure-sensitive adhesive obtained by curing the curable composition can have good repulsion resistance, especially high-temperature and high-humidity repulsion resistance at a temperature of 85° C. and a relative humidity of 85%.

Preferably, the curable composition may further comprise a (meth)acrylate copolymer, formed via copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond; and the (meth)acrylate copolymer has a weight-average molecular weight of between 500,000 Da and 10,000,000 Da.

That is to say, the curable composition may further comprise a (meth)acrylate copolymer, which may be formed via polymerization of the same type of raw material as the above monomer component; and the presence of the above copolymer facilitates the improvement of quality of the pressure-sensitive adhesive formed of the curable composition. Particularly, the viscosity of the curable composition can be adjusted by changing the content of the above copolymer to make it fit for practical use. Of course, because the above monomer component actually also forms a (meth)acrylate copolymer after copolymerization, it is feasible that the curable composition contains no (meth)acrylate copolymer, and a pressure-sensitive adhesive is formed directly via polymerization of the monomer component when cured.

More preferably, a slurry polymer is formed with the above monomer component and the (meth)acrylate copolymer; and the slurry polymer is formed via partial copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond.

In other words, a raw material comprising specific polymerizable monomers can be used to carry out partial copolymerization, thereby forming a mixture formed of the monomer and the copolymer, i.e., a slurry polymer. In the slurry polymer, some polymerizable monomers have been copolymerized to form a copolymer, i.e., the above (meth)acrylate copolymer; and at the same time, the other polymerizable monomers have not yet been copolymerized and are kept in the monomer form, i.e., the above monomer component. In the slurry polymer, the unpolymerized polymerizable monomers can serve as a solvent to dissolve the solute copolymer to then form a homogeneous system.

In the curable composition, other components such as the (meth)acrylate polymer tackifying resin and the non-(meth)acrylate polymer tackifying resin are also dissolved in the slurry polymer (or monomer component) and can also be considered as solutes in the slurry polymer.

Of course, the curable composition does not have to be prepared from a slurry polymer, and those skilled in the art can also directly prepare the curable composition by using a monomer component and a (meth)acrylate copolymer formed separately as raw materials.

Of course, when the monomer component and the (meth)acrylate copolymer are in the form of a slurry polymer, they are necessarily formed using the same raw material; however, this does not mean that the monomer component and the (meth)acrylate copolymer have the same actual ingredients, which is because that in the copolymerization process, different polymerizable monomers may have different copolymerization rates and orders.

Of course, when the curable composition is directly prepared by using a monomer component and a (meth)acrylate copolymer formed separately as raw materials, the raw material compositions of the two may also be different.

The effect, optional substance, content, and the like of each component will be introduced below.

For the sake of conciseness and convenience, the following monomer component and (meth)acrylate copolymer will be both described in the form of a slurry polymer, which should not be understood as limiting the present invention, however.

### 1. Slurry Polymer

### 1) Properties of Slurry Polymer

The slurry polymer is a mixture formed via partial copolymerization of a raw material comprising at least two polymerizable monomers, the mixture comprising unpolymerized polymerizable monomers (i.e., monomer components) and copolymers formed via copolymerization of the polymerizable monomers. Since the polymerizable monomers in the slurry polymer are only partially copolymerized, where the copolymers are not cross-linked or only marginally cross-linked, the copolymer therein still can be dissolved in the unpolymerized polymerizable monomers. Therefore, the slurry polymer is a liquid homogeneous system with fluidity and appropriate viscosity for facilitating operations such as coating.

Preferably, the copolymer (i.e. the (meth)acrylate copolymer) already formed in the slurry polymer has a weight-average molecular weight of preferably between 500,000 Da (Daltons, gm/mol) and 10,000,000 Da. Specifically, the copolymer already formed in the slurry polymer may have a weight-average molecular weight of at least 500,000 Da, at least 750,000 Da, or at least 1,000,000 Da; and the weight-average molecular weight may be at most 10,000,000 Da, at most 6,000,000 Da, or at most 5,000,000 Da.

Preferably, at 22° C., the slurry polymer has a viscosity of preferably between 500 centipoise (cPs) and 10,000 centipoise. Specifically, the slurry polymer may have a viscosity of at least 500 centipoise, at least 1,500 centipoise, or at least 2,500 centipoise; and the viscosity may be at most 10,000 centipoise, at most 7,000 centipoise, or at most 5,500 centipoise.

Preferably, in the polymerizable monomers for forming the slurry polymer, a weight proportion of the polymerizable monomers that have been polymerized is between 1% and 30%. In other words, if the raw material of all polymerizable monomers for forming the slurry polymer is taken as 100 parts by weight, the amount of polymerizable monomers that have been polymerized to form copolymers is from 1 part by weight to 30 parts by weight; and polymerizable monomers that have not been polymerized are from 70 parts by weight to 99 parts by weight, or the monomer conversion is from 1% to 30%. Specifically, the above monomer conversion (the weight proportion of the polymerizable monomers that have been polymerized) may be at least 1%, at least 2%, at least 5%, or at least 7%; and the monomer conversion may be at most 30%, at most 20%, at most 15%, or at most 12%.

Slurry polymers with the above viscosity, weight-average molecular weight, and monomer conversion are relatively fit for use in curable compositions.

### 2) Polymerizable Monomers for Forming Slurry Polymers

The above polymerizable monomers for forming slurry polymers comprise a non-tertiary alcohol (meth)acrylate monomer, and an acid-functional non-ester unsaturated monomer having at least one olefinic bond; and preferably further include a non-acid functional and ethylenically unsaturated polar monomer and/or a vinyl monomer.

In other words, the slurry polymer is preferably formed via partial copolymerization of a raw material comprising the above polymerizable monomers. Therefore, monomer components of the curable composition would certainly include these polymerizable monomers; and the (meth)acrylate copolymer in the curable composition is also formed via copolymerization of these polymerizable monomers.

Each polymerizable monomer will be further introduced below.

### (1) Non-Tertiary Alcohol (Meth)Acrylate Monomer

Preferably, the number of carbon atoms in the non-tertiary alcohol (meth)acrylate monomer is between 1 and 20, i.e. it is a C1 to C20 non-tertiary alcohol (meth)acrylate monomer. Specifically, the number of carbon atoms in the above non-tertiary alcohol (meth)acrylate monomer may be at least 2, or at least 4; and this number of carbon atoms may be at most 20, at most 18, or at most 12.

The segments of the non-tertiary alcohols for forming the above non-tertiary alcohol (meth)acrylate monomer may be linear, or alternatively be branched or a combination thereof. Specifically, the above non-tertiary alcohols include, but are not limited to any one or more of: methanol, ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctanol, 2-ethyl-1-hexanol, 1-decanol, 2-propylheptanol, 1-dodecanol, 1-tridecanol, and 1-tetradecanol. Although the above non-tertiary alcohols are all suitable, in some preferred embodiments, the non-tertiary alcohol is preferably any one or more of butanol, iso-octyl alcohol, 2-ethylhexanol (with corresponding esters being iso-octyl (meth)acrylate, 2-ethylhexyl (meth)acrylate, and butyl (meth)acrylate); and in other preferred embodiments, the non-tertiary alcohol is derived from an alcohol of renewable sources, such as any one or more of 2-octanol, citronellol, and dihydrocitronellol.

In polymerizable monomers for forming the slurry polymer (i.e., the monomer component, and the polymerizable monomers for forming the (meth)acrylate copolymer), the non-tertiary alcohol (meth)acrylate monomer has a weight percentage of between 84% and 99%.

That is to say, in every 100 parts by weight of the polymerizable monomers for forming the slurry polymer, the above non-tertiary alcohol (meth)acrylate monomer preferably accounts for 84 parts by weight to 99 parts by weight. Specifically, the above non-tertiary alcohol (meth)acrylate monomer may be at least 84 parts by weight, at least 86 parts by weight, or at least 89 parts by weight; and the above non-tertiary alcohol (meth)acrylate monomer may be at most 99 parts by weight, at most 98.5 parts by weight, or at most 96 parts by weight.

In the above non-tertiary alcohol (meth)acrylate monomer, preferably a portion thereof has a high Tg (glass transition temperature), i.e., the homopolymer thereof has a Tg of at least 25° C., and preferably at least 50° C. These high-Tg non-tertiary alcohol (meth)acrylate monomers include, but are not limited to any one or more of: methyl methacrylate, ethyl methacrylate, isopropyl methacrylate, n-butyl methacrylate, i-butyl methacrylate, s-butyl methacrylate, stearyl alcohol methacrylate, phenyl methacrylate, cyclohexyl methacrylate, isobornyl acrylate, isobornyl methacrylate, benzoyl methacrylate, 3,3,5-trimethylcyclohexyl acrylate, cyclohexyl acrylate, N-octyl acrylamide, and propyl methacrylate.

In every 100 parts by weight of the polymerizable monomers for forming the slurry polymer, the high-Tg non-tertiary alcohol (meth)acrylate monomer preferably accounts for 0 part by weight to 25 parts by weight (0 part means that it does not have to be included). Specifically, none or at least 2 parts by weight of, or at least 5 parts by weight of the above high-Tg non-tertiary alcohol (meth)acrylate monomer may be included; and the high-Tg non-tertiary alcohol (meth)acrylate monomer may be at most 25 parts by weight, at most 20 parts by weight, or at most 15 parts by weight.

The amount of the high-Tg non-tertiary alcohol (meth)acrylate monomer is included in the amount of all the non-tertiary alcohol (meth)acrylate monomers. For example, if the total amount of non-tertiary alcohol (meth)acrylate monomers is 97 parts by weight and the amount of high-Tg non-tertiary alcohol (meth)acrylate monomer is 10 parts by weight, it means that in the total 97 parts by weight of non-tertiary alcohol (meth)acrylate monomers, 10 parts by weight thereof have a high Tg and the rest 87 parts by weight thereof are other non-tertiary alcohol (meth)acrylate monomers with a lower Tg.

### (2) Acid-Functional Non-Ester Unsaturated Monomer Having at Least One Olefinic Bond

The acid-functional non-ester unsaturated monomer having at least one olefinic bond comprises both an olefinic bond and an acid functional group, wherein the acid functional group may be acid like carboxylic acid, or a salt of acid, like an alkali metal salt of carboxylic acid; but it cannot an ester. The acid-functional non-ester unsaturated monomer having at least one olefinic bond may be ethylenically unsaturated carboxylic acid, ethylenically unsaturated sulfonic acid, ethylenically unsaturated phosphonic acid and the like; particularly, they include, but are not limited to any one or more of: acrylic acid, methacrylic acid, itaconic acid, fumaric acid, crotonic acid, citraconic acid, maleic acid, oleic acid, styrene sulfonic acid, 2-acrylamide-2-methyl propanesulfonic acid, and vinyl phosphonic acid. In consideration of easy implementation, the acid-functional non-ester unsaturated monomer having at least one olefinic bond is more preferably ethylenically unsaturated carboxylic acid, such as (meth)acrylic acid.

In polymerizable monomers for forming the slurry polymer (i.e., the monomer component, and the polymerizable monomers for forming the (meth)acrylate copolymer), the above acid-functional non-ester unsaturated monomer having at least one olefinic bond has a weight percentage of between 1% and 4%.

That is to say, in every 100 parts by weight of the polymerizable monomers for forming the slurry polymer, the above acid-functional non-ester unsaturated monomer having at least one olefinic bond preferably accounts for 1 part by weight to 4 parts by weight. Specifically, the above acid-functional non-ester unsaturated monomer having at least one olefinic bond may be at least 1 part by weight, at least 1.5 parts by weight, or at least 2 parts by weight; and the acid-functional non-ester unsaturated monomer having at least one olefinic bond may be at most 4 parts by weight, at most 3.5 parts by weight, or at most 3 parts by weight.

### (3) Non-Acid Functional and Ethylenically Unsaturated Polar Monomer

Preferably, the polymerizable monomers for forming the slurry polymer may further comprise non-acid functional and ethylenically unsaturated polar monomers (which may be esters but are different from the non-tertiary alcohol (meth)acrylate monomer mentioned earlier). Therein, useful non-acid functional and ethylenically unsaturated polar monomers include, but are not limited to any one or more of: 2-hydroxyethyl (meth)acrylate, N-vinylpyrrolidone, N-vinylcaprolactam, acrylamide, mono-N-alkyl substituted acrylamide, bis-N-alkyl substituted acrylamide, tert-butyl acrylamide, dimethylaminoethyl acrylamide, N-octyl acrylamide, poly(alkoxyalkyl)(meth)acrylate; wherein, poly(alkoxyalkyl)(meth)acrylates comprise any one or more of 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylate. In polymerizable monomers for forming the slurry polymer (i.e., the monomer component, and the polymerizable monomers for forming the (meth)acrylate copolymer), the non-acid functional and ethylenically unsaturated polar monomer has a weight percentage of less than or equal to 15%.

That is to say, in every 100 parts by weight of the polymerizable monomers for forming the slurry polymer, the non-acid functional and ethylenically unsaturated polar monomer preferably accounts for 0 part by weight to 15 parts by weight (0 part means that it does not have to be included). Specifically, none or at least 1 part by weight of, or at least 2 parts by weight of the non-acid functional and ethylenically unsaturated polar monomer may be comprised; and the non-acid functional and ethylenically unsaturated polar monomer may be at most 15 parts by weight, at most 12 parts by weight, or at most 9 parts by weight.

### (4) Vinyl Monomer

Preferably, the polymerizable monomers for forming the slurry polymer may further comprise a vinyl monomer, which is a monomer having a vinyl group as an important part, including, but not limited to any one or more of: vinyl esters (e.g., vinyl acetate and vinyl propionate), styrene, substituted styrene (e.g., α-methylstyrene), and vinyl halides. Apparently, the vinyl monomer described herein does not include the other monomers mentioned above; that is to say, it is different from the above non-tertiary alcohol (meth)acrylate monomers, acid-functional non-ester unsaturated monomers having at least one olefinic bond, and non-acid functional and ethylenically unsaturated polar monomers. In polymerizable monomers for forming the slurry polymer (i.e., the monomer component, and the polymerizable monomers for forming the (meth)acrylate copolymer), the vinyl monomer has a weight percentage of less than or equal to 5%.

That is to say, in every 100 parts by weight of the polymerizable monomers for forming the slurry polymer, the vinyl monomer preferably accounts for 0 part by weight to 5 parts by weight (0 part means that it does not have to be included). Specifically, none or at least 0.5 parts by weight of, or at least 1 part by weight of the vinyl monomer may be included; and the vinyl monomer may be at most 5 parts by weight, at most 4 parts by weight, or at most 3 parts by weight.

The above non-acid functional and ethylenically unsaturated polar monomer and vinyl monomer are optional components. That is to say, they may not be included in the polymerizable monomers for forming the slurry polymer (i.e., the monomer component, and the polymerizable monomers for forming the (meth)acrylate copolymer); yet, it is a known technique to optionally include these components to improve the performance of the slurry polymers.

### 2. (Meth)Acrylate Polymer Tackifying Resin

### 1) Properties of (Meth)Acrylate Polymer Tackifying Resin

A (meth)acrylate polymer tackifying resin refers to a tackifying resin formed via polymerization of raw materials comprising (meth)acrylate monomers, with a weight-average molecular weight of between 10,000 Da and 60,000 Da and a glass transition temperature (Tg) greater than or equal to 20° C.

Specifically, the (meth)acrylate polymer tackifying resin may have a weight-average molecular weight of at least 10,000 Da, at least 15,000 Da, or at least 20,000 Da; and the weight-average molecular weight may be at most 60,000 Da, at most 50,000 Da, or at most 40,000 Da. The (meth)acrylate polymer tackifying resin has a glass transition temperature of at least 20° C., at least 40° C., or at least 50° C.

The repulsion resistance of the pressure-sensitive adhesive formed of the curable composition can be improved when the (meth)acrylate polymer tackifying resin satisfies the above weight-average molecular weight and glass transition temperature conditions. Therein, the weight ratio of the (meth)acrylate polymer tackifying resin to the total weight of the monomer component and the polymerizable monomers for forming the (meth)acrylate copolymer (i.e. the total weight of the polymerizable monomers for forming the slurry polymer) is between 5% and 18%. That is to say, in the curable composition, based on every 100 parts by weight of the polymerizable monomers for forming the slurry polymer (i.e. the monomer component and the polymerizable monomers for forming the (meth)acrylate copolymer), the amount of the (meth)acrylate polymer tackifying resin is 5 parts by weight to 18 parts by weight. Specifically, the amount of the (meth)acrylate polymer tackifying resin may be at least 5 parts by weight, at least 6 parts by weight, or at least 8 parts by weight; and the amount of the (meth)acrylate polymer tackifying resin may be at most 18 parts by weight, at most 12 parts by weight, or at most 10 parts by weight.

### 2) Polymerizable Monomers for Forming the (Meth)Acrylate Polymer Tackifying Resin

Preferably, the above (meth)acrylate polymer tackifying resin is formed via copolymerization of raw materials comprising at least two polymerizable monomers, wherein the polymerizable monomers comprise (meth)acrylate monomers.

More preferably, the polymerizable monomers for forming (meth)acrylate polymer tackifying resin comprise a non-tertiary alcohol (meth)acrylate monomer, and an acid-functional non-ester unsaturated monomer having at least one olefinic bond; and preferably may further comprise a non-acid functional and ethylenically unsaturated polar monomer and/or a vinyl monomer.

That is to say, the (meth)acrylate polymer tackifying resin is preferably formed by polymerizable monomers of the same type as the polymerizable monomers for forming the slurry polymer. However, the (meth)acrylate polymer tackifying resin is a substantially completely polymerized polymer rather than a mixture resulted from partial copolymerization.

It should be understood that the above description only indicates that the types of polymerizable monomers for forming the (meth)acrylate polymer tackifying resin and the slurry polymer are the same, but does not indicate that the types, amounts, and the like of the polymerizable monomers used for them are necessarily the same (of course they can be the same).

Each polymerizable monomer will be further introduced below.

### (1) Non-Tertiary Alcohol (Meth)Acrylate Monomer

That is to say, non-tertiary alcohol (meth)acrylate monomers are also preferably used for the (meth)acrylate monomer in the (meth)acrylate polymer tackifying resin. Therein, the optional specific types of the non-tertiary alcohol (meth)acrylate monomer are the same as those of the non-tertiary alcohol (meth)acrylate monomer described above for forming the slurry polymer, which will not be described herein in detail.

Preferably, in the polymerizable monomers for forming the (meth)acrylate polymer tackifying resin, the non-tertiary alcohol (meth)acrylate monomer has a weight percentage of between 59.5% and 99.5%, preferably between 90% and 99%.

That is to say, in every 100 parts by weight of the polymerizable monomers for forming the (meth)acrylate polymer tackifying resin, the non-tertiary alcohol (meth)acrylate monomer preferably accounts for 59.5 parts by weight to 99.5 parts by weight.

Specifically, the non-tertiary alcohol (meth)acrylate monomer may be at least 59.5 parts by weight, at least 80 parts by weight, or at least 90 parts by weight; and the non-tertiary alcohol (meth)acrylate monomer may be at most 99.5 parts by weight, at most 99 parts by weight, or at most 97 parts by weight. As can be seen, the proportion of the non-tertiary alcohol (meth)acrylate monomer in the raw material herein may be different from that in the raw material for forming the slurry polymer.

In the non-tertiary alcohol (meth)acrylate monomer, preferably a portion thereof has a high glass transition temperature (Tg), i.e., the homopolymer thereof has a Tg of at least 25° C., and preferably at least 50° C. In every 100 parts by weight of the polymerizable monomers for forming the (meth)acrylate polymer tackifying resin, the high-Tg non-tertiary alcohol (meth)acrylate monomer preferably accounts for 0 part by weight to 99.5 parts by weight, preferably 1 part by weight to 97 parts by weight; the amount of the high-Tg non-tertiary alcohol (meth)acrylate monomer is included in the amount of all the non-tertiary alcohol (meth)acrylate monomers. That is to say, unlike the polymerizable monomers for forming the slurry polymer, in polymerizable monomers for forming the (meth)acrylate polymer tackifying resin, all the non-tertiary alcohol (meth)acrylate monomer may be high-Tg.

### (2) Acid-Functional Non-Ester Unsaturated Monomer Having at Least One Olefinic Bond

The acid-functional non-ester unsaturated monomer having at least one olefinic bond comprises both olefinic bonds and acid functional groups. Therein, the optional specific types of the acid-functional non-ester unsaturated monomer having at least one olefinic bond may be the same as those of the acid-functional non-ester unsaturated monomer having at least one olefinic bond described above for forming the slurry polymer, which will not be described herein in detail.

In polymerizable monomers for forming the (meth)acrylate polymer tackifying resin, the acid-functional non-ester unsaturated monomer having at least one olefinic bond has a weight percentage of between 0.5% and 15%, and preferably between 1% and 10%. That is to say, in every 100 parts by weight of the polymerizable monomers for forming the (meth)acrylate polymer tackifying resin, the above acid-functional non-ester unsaturated monomer having at least one olefinic bond preferably accounts for 0.5 parts by weight to 15 parts by weight. Specifically, the acid-functional non-ester unsaturated monomer having at least one olefinic bond may be at least 0.5 parts by weight, at least 1 part by weight, or at least 3 parts by weight; and the acid-functional non-ester unsaturated monomer having at least one olefinic bond may be at most 15 parts by weight, at most 10 parts by weight, or at most 6 parts by weight.

### (3) Non-Acid Functional and Ethylenically Unsaturated Polar Monomer

Preferably, the polymerizable monomers for forming the (meth)acrylate polymer tackifying resin may further comprise a non-acid functional and ethylenically unsaturated polar monomer (which may include esters). Therein, the optional specific types of the non-acid functional and ethylenically unsaturated polar monomer may be the same as those of the non-acid functional and ethylenically unsaturated polar monomer described above for forming the slurry polymer, which will not be described herein in detail.

In polymerizable monomers for forming the (meth)acrylate polymer tackifying resin, the non-acid functional and ethylenically unsaturated polar monomer has a weight percentage of less than or equal to 40%, preferably less than or equal to 30%.

That is to say, in every 100 parts by weight of the polymerizable monomers for forming the (meth)acrylate polymer tackifying resin, the non-acid functional and ethylenically unsaturated polar monomer preferably accounts for 0 part by weight to 40 parts by weight (0 part means that it does not have to be included). Specifically, none or at least 2 parts by weight of, or at least 5 parts by weight of the above non-acid functional and ethylenically unsaturated polar monomer may be included; and the non-acid functional and ethylenically unsaturated polar monomer may be at most 40 parts by weight, at most 30 parts by weight, or at most 20 parts by weight.

### (4) Vinyl Monomer

Preferably, the polymerizable monomers for forming the (meth)acrylate polymer tackifying resin may further include a vinyl monomer, which is a monomer having a vinyl group as an important part. Therein, the optional specific types of the vinyl monomer may be the same as those of the vinyl monomer described above for forming the slurry polymer, which will not be described herein in detail. Apparently, the vinyl monomer described herein is also different from the above non-tertiary alcohol (meth)acrylate monomer, acid-functional non-ester unsaturated monomer having at least one olefinic bond, and non-acid functional and ethylenically unsaturated polar monomer.

In the polymerizable monomers for forming the (meth)acrylate polymer tackifying resin, the vinyl monomer has a weight percentage of less than or equal to 5%.

That is to say, in every 100 parts by weight of the polymerizable monomers for forming the (meth)acrylate polymer tackifying resin, the vinyl monomer preferably accounts for 0 part by weight to 5 parts by weight (0 part means that it does not have to be included). Specifically, none or at least 1 part by weight of the vinyl monomer may be included; and the vinyl monomer may be at most 5 parts by weight, at most 4 parts by weight, or at most 3 parts by weight.

The above non-acid functional and ethylenically unsaturated polar monomer and vinyl monomer are optional components. That is to say, they may not be included in the polymerizable monomers for forming the (meth)acrylate polymer tackifying resin; yet, it is a known technique to use them in the (meth)acrylate polymer tackifying resin as an alternative component to improve the performance of the (meth)acrylate polymer tackifying resin.

### 3) Other Components in the Raw Material for Forming the (Meth)Acrylate Polymer Tackifying Resin

The raw material for forming the (meth)acrylate polymer tackifying resin may also include any one or more of the following components:

chain transfer agents;
additional photoinitiators.

It should be understood that the above components are not polymerizable monomers for forming the (meth)acrylate polymer tackifying resin, and therefore the amount thereof is not a part of the polymerizable monomers, but is added in an amount relative to the amount of the polymerizable monomers; however, since the (meth)acrylate polymer tackifying resin is substantially completely polymerized, these components will be cured in the (meth)acrylate polymer tackifying resin, and therefore the amount thereof is a part of the amount of the (meth)acrylate polymer tackifying resin.

The specific optional components will be introduced below.

### (1) Chain Transfer Agents

Since the (meth)acrylate polymer tackifying resin must have a specific weight-average molecular weight and a glass transition temperature (Tg), chain transfer agents can be added to the raw material for forming the (meth)acrylate polymer tackifying resin to adjust the weight-average molecular weight of the product thereof.

Specifically, useful chain transfer agents include, but are not limited to any one or more of carbon tetrabromide, alcohol, and mercaptan; preferably, the chain transfer agents may be any one or more of isooctyl thioglycolate, carbon tetrabromide, and tert-dodecyl mercaptan.

Preferably, a weight ratio of the chain transfer agents to a total weight of the polymerizable monomers for forming the (meth)acrylate polymer tackifying resin is between 0.01% and 5%.

That is to say, when the polymerizable monomers for forming the (meth)acrylate polymer tackifying resin account for 100 parts by weight, the amount of chain transfer agents preferably accounts for 0.01 to 5 parts by weight. Specifically, the amount of the chain transfer agents may be at least 0.01 parts by weight, at least 0.02 parts by weight, at least 0.03 parts by weight, or at least 0.1 parts by weight; and the amount of the chain transfer agents may be at most 5 parts by weight, at most 3 parts by weight, at most 2.5 parts by weight, or at most 2 parts by weight.

### (2) Additional Photoinitiators

That is to say, the (meth)acrylate polymer tackifying resin is preferably obtained by photopolymerization, and thus it may contain additional photoinitiators, which are used to produce free radicals under UV light irradiation, thereby initiating polymerization reactions.

The advantage of photoinitiated preparation is that no solvent or heating is needed throughout the preparation process of the curable composition and the pressure-sensitive adhesive, resulting in low energy consumption, fast speed, high efficiency and no pollution.

Therein, the useful additional photoinitiators include, but are not limited to any one or more of: benzoyl ether, such as benzoin methyl ether and benzoin isopropyl ether; substituted acetophenone, such as 2,2-dimethoxyacetophenone; dimethoxy hydroxyacetophenone; substituted a-keto alcohols, such as 2-methyl-2-hydroxypropiophenone; aromatic sulfonyl chloride such as 2-naphthalene-sulfonyl chloride; photosensitive oxime, such as 1-phenyl-1,2-propanedione-2-(0-ethoxy-carbonyl)oxime; 1-hydroxycyclohexyl phenyl ketone; 1-[4-(2-hydroxyethoxy)phenyl]-2-hydroxy-2-methyl-1-propan-1-one; (4-methylthiobenzoyl)-1-methyl-1-morpholinylethane; (4-morpholinylbenzoyl)-1-benzyl-1-dimethylaminopropane; (4-morpholinylbenzoyl)-1-(4-methylbenzyl)-1-dimethylaminopropane; bis(2,4,6-trimethylbenzoyl)phenylphosphine oxide; 1-hydroxycyclohexyl benzophenone. Of these, a particularly preferred additional photoinitiator is a substituted acetophenone.

Preferably, a weight ratio of the additional photoinitiators to a total weight of the polymerizable monomers for forming the (meth)acrylate polymer tackifying resin is between 0.005% and 5%.

That is to say, when the polymerizable monomers for forming the (meth)acrylate polymer tackifying resin account for 100 parts by weight, the amount of additional photoinitiators accounts for 0.005 parts by weight to 5 parts by weight. Specifically, the additional photoinitiators may be used in an amount of at least 0.005 parts by weight, at least 0.03 parts by weight, or at least 0.05 parts by weight; and at most 5 parts by weight, at most 3 parts by weight, or at most 2 parts by weight.

It should be understood that the additional photoinitiators herein have reacted and becomes a part of the (meth)acrylate polymer tackifying resin (i.e., they are actually no longer photoinitiators), and therefore, the amount thereof is included in the amount of the (meth)acrylate polymer tackifying resin, and is not a part of the photoinitiator in the curable composition.

It should be understood that in the preparation of the (meth)acrylate polymer tackifying resin, the above chain transfer agents, additional photoinitiators or the like may be added all at once or may be added in multiple portions.

### 3. Non-(Meth)Acrylate Polymer Tackifying Resin Component

The non-(meth)acrylate polymer tackifying resin component comprises at least two non-(meth)acrylate polymer tackifying resins, wherein at least a part of non-(meth)acrylate polymer tackifying resins has a softening point greater than or equal to 130° C.

That is to say, the curable composition of the invention contains, in addition to the (meth)acrylate polymer tackifying resin, at least two other known tackifying resins that are not (meth)acrylate polymers, wherein at least a part of these tackifying resins has a softening point greater than or equal to 130° C.

Preferably, the non-(meth)acrylate polymer tackifying resin component comprises at least two tackifying resins respectively selected from the following different types of resins: hydrogenated rosin resin-type tackifying resins, hydrogenated terpene phenolic resin-type tackifying resins, and hydrocarbon resin-type tackifying resins.

That is to say, the plurality of tackifying resins in the above non-(meth)acrylate polymer tackifying resin component preferably belong to at least two or more of the above three types of tackifying resins, respectively; in other words, the non-(meth)acrylate polymer tackifying resin component preferably comprises a tackifying resin selected from two or more of the above three types of tackifying resins (of course different types of tackifying resins are certainly different); for example, the non-(meth)acrylate polymer tackifying resin component may include a hydrogenated rosin resin-type tackifying resin and a hydrogenated terpene phenolic resin-type tackifying resin. Of course, only some of the types of optional tackifying resins are exemplified herein, and the non-(meth)acrylate polymer tackifying resin component also includes other types of tackifying resins meeting requirements.

Therein, the weight ratio of the non-(meth)acrylate polymer tackifying resin component to the total weight of the monomer component and the polymerizable monomers for forming the (meth)acrylate copolymer (i.e. the total weight of the polymerizable monomers for forming the slurry polymer) is between 8% and 18%, preferably between 8% and 15%. That is to say, in the curable composition, based on every 100 parts by weight of the polymerizable monomers for forming the slurry polymer (i.e. the monomer component and the polymerizable monomers for forming the (meth)acrylate copolymer), the total amount of the above non-(meth)acrylate polymer tackifying resin is between 8 parts by weight and 18 parts by weight. Specifically, the total amount of the above non-(meth)acrylate polymer tackifying resin may be at least 8 parts by weight, or at least 10 parts by weight; and the amount of the non-(meth)acrylate polymer tackifying resin may be at most 18 parts by weight, at most 15 parts by weight, or at most 14 parts by weight. Therein, the weight ratio of each tackifying resin in the (meth)acrylate polymer tackifying resin component to the total weight of the monomer component and the polymerizable monomers for forming the (meth)acrylate copolymer (i.e. the polymerizable monomers for forming the slurry polymer) is greater than or equal to 1%.

That is to say, in the curable composition, based on every 100 parts by weight of the polymerizable monomers for forming the slurry polymer (i.e. the monomer component and the polymerizable monomers for forming the (meth)acrylate copolymer), each tackifying resin in the above non-(meth)acrylate polymer tackifying resin component should be at least 1 part by weight, preferably 2 parts by weight, and more preferably 3 parts by weight.

At the same time, in the above non-(meth)acrylate polymer tackifying resin component, at least a part of the non-(meth)acrylate polymer tackifying resins has a softening point greater than or equal to 130° C.

That is to say, in the non-(meth)acrylate polymer tackifying resin component, at least a part of the non-(meth)acrylate polymer tackifying resins has a softening point greater than or equal to 130° C., thereby ensuring excellent high-temperature and high-humidity repulsion resistance of the pressure-sensitive adhesive formed of the curable composition. Of course, it is also feasible that all the non-(meth)acrylate polymer tackifying resins in the above non-(meth)acrylate polymer tackifying resin component have a softening point greater than or equal to 130° C.

Therein, a weight ratio of the non-(meth)acrylate polymer tackifying resins, having a softening point greater than or equal to 130° C. in the non-(meth)acrylate polymer tackifying resin component, to a total weight of the monomer component and the polymerizable monomers for forming the (meth)acrylate copolymer (i.e. the polymerizable monomers for forming the slurry polymer) is greater than or equal to 6%, more preferably between 8% and 14%.

That is to say, in the curable composition, based on every 100 parts by weight of the polymerizable monomers for forming the slurry polymer (i.e. the monomer component and the polymerizable monomers for forming the (meth)acrylate copolymer), the amount of the above non-(meth)acrylate polymer tackifying resins having a softening point greater than or equal to 130° C. is at least 6 parts by weight, and preferably 8 parts by weight to 14 parts by weight. Specifically, the amount of the above non-(meth)acrylate polymer tackifying resins having a softening point greater than or equal to 130° C. may be at least 6 parts by weight, at least 7 parts by weight, or at least 8 parts by weight; and the amount of the non-(meth)acrylate polymer tackifying resins having a softening point greater than or equal to 130° C. may be at most 14 parts by weight, at most 13 parts by weight, or at most 12 parts by weight.

### 4. Cross-Linking Agent Component

The curable composition of the present invention also contains a cross-linking agent component, and the cross-linking agent component must include an isocyanate cross-linking agent and a non-isocyanate cross-linking agent.

### 1) Non-Isocyanate Cross-Linking Agent

That is to say, the above cross-linking agent component must comprise at least one cross-linking agent that is not an isocyanate.

Preferably, the non-isocyanate cross-linking agent is a non-thermosensitive non-isocyanate cross-linking agent. For example, the non-isocyanate cross-linking agent may comprise a photosensitive cross-linking agent which may be activated by UV light irradiation. Common photosensitive cross-linking agents include, but are not limited to: benzophenone cross-linking agents; copolymerizable aromatic ketone cross-linking agents; triazine cross-linking agents, such as 2,4-bis(trichloromethyl)-6-(4-methoxyphenyl)-triazine. Another useful non-isocyanate cross-linking agent is a polyfunctional (meth)acrylate, such as di(meth)acrylate, tri(meth)acrylate, and tetra(meth)acrylate. Specific examples include, but are not limited to any one or more of: 1,6-hexanediol di(meth)acrylate, poly(ethylene glycol) di(meth)acrylate, polybutadiene di(meth)acrylate, polyurethane di(meth)acrylate, propoxylated glycerol tris(meth)acrylate. The polyfunctional (meth)acrylate cross-linking agent is a non-photosensitive cross-linking agent, but may improve the cohesive strength of the acrylate pressure-sensitive adhesive (see U.S. Pat. No. 4,379,201).

Therein, the preferred non-isocyanate cross-linking agent of the present invention is a triazine cross-linking agent, and is more preferably used with a polyfunctional (meth)acrylate cross-linking agent to improve the cohesive strength of the pressure-sensitive adhesive.

Preferably, the weight ratio of the above non-isocyanate cross-linking agent to the total weight of the monomer component and the polymerizable monomers for forming the (meth)acrylate copolymer (i.e. the total weight of the polymerizable monomers for forming the slurry polymer) is less than or equal to 5%, more preferably between 0.01% and 2%, further preferably between 0.03% and 1%.

### 2) Isocyanate Cross-Linking Agent

That is to say, the above cross-linking agent component must also comprise at least one cross-linking agent that is an isocyanate.

The isocyanate cross-linking agent is used in the preparation of polyurethane coatings and the like, which can be cross-linked by heating (i.e., a thermal cross-linking agent) to improve cohesive strength within the system.

The present invention inventively found that, in a curable composition for forming an acrylate pressure-sensitive adhesive that meets the above requirements, by using both an isocyanate cross-linking agent and at least one other cross-linking agent, the pressure-sensitive adhesive obtained by curing the curable composition can have good repulsion resistance, especially high-temperature and high-humidity repulsion resistance at a temperature of 85° C. and a relative humidity of 85%.

The reason for the improvement of the high-temperature and high-humidity repulsion resistance of the pressure-sensitive adhesive may be as follows (but the following is not a limitation on the principle of action of the present invention): as one of the thermal cross-linking agents, the isocyanate cross-linking agent may not completely react during the preparation of the pressure-sensitive adhesive; when the pressure-sensitive adhesive is subjected to a high temperature and high humidity environment, the remaining isocyanate cross-linking agent can continue to react, resulting in further cross-linking of the pressure-sensitive adhesive leading to better properties such as repulsion resistance.

Preferably, the isocyanate cross-linking agent may be a non-blocked isocyanate cross-linking agent, which may specifically comprise Desmodur L75, Desmodur L1470, Desmodur VPLS2394, Desmodur N3200, Desmodur N3300, Desmodur N3400, and Desmodur N3800 isocyanate cross-linking agents, most preferably Desmodur L75 isocyanate cross-linking agent (Covestro, Leverkusen, Germany).

Preferably, the weight ratio of the non-isocyanate cross-linking agent to the total weight of the monomer component and the polymerizable monomers for forming the (meth)acrylate copolymer (i.e. the total weight of the polymerizable monomers for forming the slurry polymer) is less than or equal to 1.2%, more preferably between 0.1% and 1.2%, further preferably between 0.2% and 1%.

### 5. Photoinitiator

Preferably, the curable composition of the present invention is photoinitiated; and thus it may contain a photoinitiator. A photoinitiator is used to produce free radicals under UV light irradiation, thereby initiating polymerization reaction. During the photoinitiation process, no additional organic solvents (i.e., solvents other than the polymerizable monomers) are used, so that the whole production process substantially is wastewater or exhaust gas pollution free and has high efficiency. Moreover, polymerization is initiated with UV light in the photoinitiation, which means that on the one hand, no heating is needed and the process is simple and feasible, low in power consumption and high in efficiency; and on the other hand, when the UV light source is turned off and the air (or oxygen) is charged therein, the reactions can be terminated immediately. Thus the viscosity, monomer conversion, weight-average molecular weight and the like of the product thereof can be controlled accurately.

Therein, the specific photoinitiators that may be used include, but are not limited to any one or more of: benzoyl ether, such as benzoin methyl ether and benzoin isopropyl ether; substituted acetophenone, such as 2,2-dimethoxyacetophenone; dimethoxy hydroxyacetophenone; substituted a-keto alcohols, such as 2-methyl-2-hydroxypropiophenone; aromatic sulfonyl chloride such as 2-naphthalene-sulfonyl chloride; photosensitive oxime, such as 1-phenyl-1,2-propanedione-2-(0-ethoxy-carbonyl)oxime; 1-hydroxycyclohexyl phenyl ketone; 1-[4-(2-hydroxyethoxy)phenyl]-2-hydroxy-2-methyl-1-propan-1-one; (4-methylthiobenzoyl)-1-methyl-1-morpholinylethane; (4-morpholinylbenzoyl)-1-benzyl-1-dimethylaminopropane; (4-morpholinylbenzoyl)-1-(4-methylbenzyl)-1-dimethylaminopropane; bis(2,4,6-trimethylbenzoyl)phenylphosphine oxide; 1-hydroxycyclohexyl benzophenone. Of these, a particularly preferred photoinitiator is substituted acetophenone.

Therein, the weight ratio of the photoinitiator to the total weight of the monomer component and the polymerizable monomers for forming the (meth)acrylate copolymer (i.e. the polymerizable monomers for forming the slurry polymer) is between 0.001% and 3%.

That is to say, in the curable composition, based on every 100 parts by weight of the polymerizable monomers for forming the slurry polymer (i.e. the monomer component and the polymerizable monomers for forming the (meth)acrylate copolymer), the amount of the photoinitiator is between 0.001 parts by weight and 3 parts by weight. Specifically, the photoinitiator may be used in an amount of at least 0.001 parts by weight, at least 0.005 parts by weight, or at least 0.01 parts by weight; and at most 3 parts by weight, at most 1 part by weight, or at most 0.5 parts by weight.

### 6. Other Additives (Such as Thickeners, Plasticizers, Dyes, Antioxidants, Dispensing Agents, Anti-Setting Agents and UV Stabilizers) and Functional Components

Preferably, in order to improve different performance of product adhesive tapes, other various known additives may be added into the curable composition; and optional additives include, but are not limited to any one or more of: thickeners (such as fumed silica), plasticizers, dyes, antioxidants, dispensing agents, anti-setting agents and UV stabilizers.

In addition, preferably, in order to provide the product of adhesive tapes with specific needed functions, functional components, such as particles with specific electro-conductive, magnetic conductive and thermally conductive performance, short fibers, flakes, expandable polymer microspheres and expanded polymer microspheres, may be further added into the curable composition.

In addition, preferably, in order to provide the product of adhesive tapes with foam characteristics, glass microbeads may be further added into the curable composition.

In addition, preferably, in order to adjust the color of the product of adhesive tapes, black pigments may be further added into the curable composition.

It should be understood that the above various optional components should be added under the premise that the intrinsic performance (especially the repulsion resistance) of the pressure-sensitive adhesive is not affected.

At the same time, those skilled in the art may further add other known components into the curable composition if needed, which will not be described herein in detail.

### Preparation Method of Curable Composition

The above curable composition can be obtained by uniformly mixing various raw materials. There are no special requirements for the order and method of the above mixing.

Preparation processes of a portion of the main raw materials of the curable composition will be described below.

### 1. Preparation Method of Slurry Polymer

When a slurry polymer is used as a raw material of a curable composition, the preparation method of the slurry polymer mainly comprises two methods: one is UV initiated bulk polymerization, referred to as UV initiation method; and the other is heat initiated solution polymerization, referred to as solution method. The two methods will be introduced below in detail.

### 1) UV Initiation Method

In the UV initiation method, no additional solvent is used; instead, raw materials of polymerizable monomers are directly mixed and partially copolymerized (bulk polymerization); and the unpolymerized polymerizable monomer therein is used as a solvent to dissolve the copolymer formed in the polymerization, so as to obtain a slurry polymer. The process of the UV initiation method particularly includes:

### (1) Preparation of Raw Material

This step is to mix various polymerizable monomers for forming the slurry polymer. If the polymerizable monomers contain the above high-Tg non-tertiary alcohol (meth)acrylate monomers, they may be added in this step in one batch (each embodiment of the present invention employs this method), or alternatively only a portion or none of the polymerizable monomers is added. The portion that is not added should be added directly into the slurry polymer that has finished the partial copolymerization. The reason to do so is that the polymerization of the high-Tg non-tertiary alcohol (meth)acrylate monomer is usually slow; and the addition at this time will not promote polymerization in a great amount.

Therefore, for the finally produced slurry polymer product, at least contents of the high-Tg non-tertiary alcohol (meth)acrylate monomer in polymerized and unpolymerized portions are different. In other words, in the curable composition, specific ingredients (including contents) of the polymerizable monomer raw materials that correspond to the monomer component and the (meth)acrylate copolymer may be different.

In this step, it also needs to mix all or some of the photoinitiators in the curable composition with the above polymerizable monomer, so as to initiate the polymerization reaction using UV initiation. Generally, the photoinitiator added in this step is a part of the photoinitiator of the curable composition, in a weight percentage content of 10% to 20% based on the total amount.

### (2) UV-Irradiation of the Above Raw Materials, so as to Enable Partial Copolymerization of the Polymerizable Monomers to Obtain the Slurry Polymer

The available UV sources are generally divided into two categories: the first is low-intensity UV sources, such as black light, with a wavelength from 280 nm to 400 nm, and an intensity generally of 10 milliwatts/square centimeter (mw/cm²) or less; the second is high-intensity UV sources such as medium pressure mercury lamps, with an intensity generally greater than 10 milliwatts/square centimeter, and more preferably between 15 milliwatts/square centimeter and 450 milliwatts/square centimeter. The UV intensity is measured using the UVIMAPTM UM 365 L-S radiometer (General Electronic Instrument Technology Co. Ltd., Virginia State, U.S.A.) by following the rules of the United States National Institute of Standards and Technology (NIST). In the present invention, preferably a low-intensity ultraviolet source with a ultraviolet intensity from 0.1 milliwatts/square centimeter to 150 milliwatts/square centimeter is used. Specifically, the above UV intensity is at least 0.1 milliwatts/square centimeter, or at least 0.5 milliwatts/square centimeter; and the UV intensity is at most 150 milliwatts/square centimeter, at most 100 milliwatts/square centimeter, or at most 50 milliwatts/square centimeter. The UV-irradiation time can be adjusted according to the light intensity and the polymerization situation, which is approximately several minutes in general.

In the polymerization process, the slurry polymer is continuously measured for the viscosity with a ubbelohde viscometer and the refractive index to judge the monomer conversion therein. After the predetermined standards are met, the UV-light is removed and air or oxygen is introduced into the slurry polymer to quench the free radicals and terminate the polymerization.

In the preparation process of the UV initiation method, no additional organic solvents (i.e., solvents other than the polymerizable monomers) are used, so that the whole production process substantially is wastewater or exhaust gas pollution free, environmentally friendly and has high efficiency. Also, polymerization is initiated with ultraviolet light in the photoinitiation, which means that on the one hand, no heating is needed and the process is simple and feasible, low in power consumption and high in efficiency; and on the other hand, when the UV light source is turned off and the gas is charged therein, the reactions can be terminated immediately. Thus the viscosity, monomer conversion, weight-average molecular weight and the like of the product thereof can be controlled accurately. Therefore, the UV initiation method is a preferred method for preparing a slurry polymer in this invention. In various embodiments of the present invention, slurry polymers are all prepared using this method.

### 2) Solution Method

The above slurry polymer may also be prepared using the solution method, wherein the polymerizable monomer can be dissolved in an additional organic solvent and polymerized; the additional organic solvent is then removed after the polymerization; and the remained substance is the slurry polymer. Particular steps of the solution method may include:

### (1) Preparation of Raw Material

Various polymerizable monomers for forming the slurry polymer, the thermal initiator and the like are dissolved in a solvent and nitrogen is charged therein for sufficient purification.

The available solvents include, but are not limited to, any one or more of: methanol, tetrahydrofuran, ethanol, isopropanol, acetone, butanone, methyl acetate, ethyl acetate, toluene, xylene, and ethylene glycol alkyl ether.

Thermal initiators are organic peroxide, organic hydroperoxide, azo compounds and the like that can generate free radicals. Useful organic peroxides include, but are not limited to any one or more of: benzoyl peroxide, lauroyl peroxide, di-tert-amyl peroxide, t-butyl peroxybenzoate, 2,5-dimethyl-2,5-di-(tert-butylperoxy)hexane, 2,5-dimethyl-2,5-di-(tert-butylperoxy)hexyne-3, and dicumyl peroxide. Useful organohydrogen peroxides include, but are not limited to tert-cyclopentadienyl hydroperoxide and/or tert-butyl hydroperoxide. Useful azo compounds include, but are not limited to any one or more of: 2,2′-azobis(isobutyronitrile), 2,2′-azobis(2-methylbutyronitrile) and 2,2′-azobis(2,4-dimethylvaleronitrile).

Based on every 100 parts by weight of the polymerizable monomer for forming the slurry polymer, the thermal initiator is added in an amount of preferably 0.05 parts by weight to 1 part by weight, more preferably 0.1 parts by weight to 0.5 parts by weight.

### (2) Heating the Solution to Partially Copolymerize the Polymerizable Monomers

The heating temperature is generally in a range of from 40° C. to 100° C.; and the heating time is generally in a range of from 1 h to 20 h. Specific selections depend on the total amount of the substances used, needed monomer conversion and the like.

### (3) Perform Vacuum Distillation to Remove the Additional Solvent to Obtain the Slurry Polymer

The particular vacuum distillation temperature can be determined according to the type of the additional solvent; and the vacuum distillation time tis determined under the premise that the additional solvent is essentially removed.

It is to be noted that although it is also feasible to prepare a slurry polymer using the solution method, the solution method is not the most ideal method, the reasons being that this method needs an additional solvent and the additional solvent removal step. This method therefore is high in cost and complex in process; additionally, this method requires heating and thus is high in power consumption. Moreover, monomers are usually polymerized more slowly in a solution and thus require a long polymerization time (generally the polymerization time is several hours; the UV initiation method only takes several minutes) and the efficiency is low.

After the slurry polymer is obtained, the product of curable composition can be obtained only by adding therein and completely dissolving the other components ((meth)acrylate polymer tackifying resin, non-(meth)acrylate polymer tackifying resin component, photoinitiator, cross-linking agent, etc.) of the curable composition, which will not be described herein in detail.

### 2. Preparation Method of the (Meth)Acrylate Polymer Tackifying Resin

Preferably, the (meth)acrylate polymer tackifying resin may be prepared internally. Therein, the preparation method of the (meth)acrylate polymer tackifying resin is similar to the preparation method of the above slurry polymer, except that the polymerizable monomers are to be substantially completely polymerized in the end. Specifically, the preparation method of (meth)acrylate polymer tackifying resin may comprise:

### (1) Preparation of Raw Material

That is to say, mix various polymerizable monomers, additional photoinitiators and chain transfer agents for forming the (meth)acrylate polymer tackifying resin.

Therein, additional photoinitiators and chain transfer agents may be added all in this step, or may be added stepwise in subsequent steps; each of the embodiments of the present invention is exemplified by the case where additional photoinitiators and chain transfer agents are all added in this step.

Unlike the preparation of the polymer slurry, the aforementioned high-Tg non-tertiary alcohol (meth)acrylate monomers, if any, should be added all in this step. This is because the (meth)acrylate polymer tackifying resin needs to be substantially completely polymerized in the end. Therefore, the earlier high-Tg non-tertiary alcohol (meth)acrylate monomers are added, the better.

### (2) UV-Irradiation of the Above Raw Materials, so as to Enable Partial Copolymerization of the Polymerizable Monomers to Obtain the Intermediate Slurry Polymer

That is to say, the above raw materials are also partially copolymerized by UV light irradiation to form the intermediate slurry polymer, which is also composed of copolymers and unpolymerized polymerizable monomers, except that the polymerizable monomers therein have a higher conversion rate, generally greater than or equal to 30%, more preferably between 40% and 80%.

Therein, the parameters of UV light and the method for detecting the conversion rate of monomers are the same as those used when preparing the slurry polymer, which will not be described herein in detail.

(3) The intermediate slurry polymer is coated between two layers of release films, and UV-irradiation is continued, to continue copolymerization of the polymerizable monomer so as to obtain a solid (meth)acrylate polymer tackifying resin product having a polymerizable monomer conversion of more than 99%.

Therein, the above method of obtaining the intermediate slurry polymer before final polymerization is employed, which is because the (meth)acrylate polymer tackifying resin product is a solid. If it is completely polymerized directly in the container, then on the one hand, the product obtained will be too large in size and inconvenient to use, and the product will be easily adhered to the container wall and difficult to remove and clean; on the other hand, the UV light will be blocked by outer material that is completely polymerized, making it difficult for the inner material to receive continuous irradiation. Thus, partial copolymerization may be carried out first to obtain an intermediate slurry polymer having a suitable viscosity, which is then coated between two layers of release films to form a flake for further polymerization.

Photoinitiation is also employed in the above method for preparing the (meth)acrylate polymer tackifying resin. Therefore, the entire preparation process of the cured composition and the pressure-sensitive adhesive is photoinitiated, wherein neither solvent nor heating is used, resulting in low energy consumption, fast speed, high efficiency and no pollution. Hence this preparation method is preferred. Of course, the above preparation method is not limited to the present invention, which may also be prepared by other methods (e.g., the solution method described above). Alternatively, if there is a commercially available product that meets the requirements, it may also be used directly as the (meth)acrylate polymer tackifying resin, eliminating the needs for separate preparation.

### Pressure-Sensitive Adhesive

The present invention further provides a pressure-sensitive adhesive, obtained by curing the above curable composition.

That is to say, the above curable composition can be substantially completely cured by means of UV-irradiation to form a pressure-sensitive adhesive having excellent high-temperature and high-humidity repulsion resistance. The UV-irradiation time can be determined under the premise that the curable composition is essentially completely cured, which generally takes roughly several minutes.

### Adhesive Tape

The present invention further provides an adhesive tape, comprising the above pressure-sensitive adhesive.

That is to say, the above pressure-sensitive adhesive can be formed as an adhesive tape for the convenience of application.

Specifically, the adhesive tape of the present invention may comprise a backing and the above pressure-sensitive adhesive is provided on the backing. When a backing is present, the above curable composition can be coated on the backing and then cured by UV-irradiation to obtain an adhesive tape comprising the backing and the pressure-sensitive adhesive. Alternatively, the curable composition may also be coated on a temporary separable substrate (e.g., a release film) and cured with UV-irradiation to form an adhesive film; and then the adhesive film of the pressure-sensitive adhesive is transferred onto other backing.

Therein, the useful backing is preferably flexible and may include plastics, such as polyolefins, such as polyethylene, polypropylene (including isotactic polypropylene), polystyrene, polyester, polyvinyl alcohol, poly(ethylene terephthalate), poly(butylene terephtalate), poly(caprolactam), poly(vinylidene fluoride), polylactide, cellulose acetate, and ethyl cellulose. Moreover, a surface of the backing may further have a specific microreplicated feature to improve the performance of the adhesive tape, and the microreplicated feature may be as those described in U.S. Pat. Nos. 5,141,790, 5,296,277, 5,362,516, etc. Alternatively, the backing may also comprise a fabric construction, the specific material of which may include synthetic or natural materials, such as fabrics of cotton, nylon, rayon, fiberglass, ceramic fibers and the like, nonwoven fabrics (such as airlaid webs of natural or synthetic fibers), or mixtures of the above materials. Alternatively, the backing may also comprise a resilient foam material, such as (meth)acrylate foam, polyethylene foam, polyurethane foam, neoprene foam, and the like. Alternatively, the backing may also comprise metals such as metal sheets, or the above plastics, fabrics, and the like that are surface metalized.

In an adhesive tape with a backing, the backing may have the above pressure-sensitive adhesive only on one side thereof and have no adhesive or have other adhesive on the other side; or the backing may have the above pressure-sensitive adhesive on both sides thereof; and the adhesive tape thus becomes a double-faced adhesive tape.

In order to facilitate the use of the adhesive tape, at least one side of the above pressure-sensitive adhesive may be provided with a release film or a release paper for protecting the pressure-sensitive adhesive when not in use for easier transfer and use of the pressure-sensitive adhesive. Specifically, the forms of the release film or release paper are numerous and well known, such as organosilicon coated kraftpaper, glassine paper, cast kraftpaper, and poly(ethylene terephthalate).

Alternatively, as another form of tapes, instead of comprising a backing, the tape may comprise only a pressure-sensitive adhesive, i.e., the tape itself is a transferable adhesive film. In this case, the tape should have at least one side comprising a release film or release paper for easier transfer of the tape. Furthermore, in this case, the pressure-sensitive adhesive may be formed directly on a release film or release paper, i.e., the above curable composition can be coated directly on a release film or release paper, and then cured by UV-irradiation to obtain a pressure-sensitive adhesive.

The above method for coating a curable composition includes, but is not limited to roll coating, flow coating, dip coating, spin coating, spray coating, knife coating, die coating and the like, which are not described herein in detail; and the dry adhesive (i.e., the pressure-sensitive adhesive) formed after the coating generally has a thickness of from 2 μm to 500 μm, more preferably from 25 μm to 400 μm, further preferably from 50 μm to 250 μm.

### Adhesive Product

The present invention further provides an adhesive product, comprising a first member, wherein at least a partial surface of the first member has the above pressure-sensitive adhesive bonded thereon.

That is, the present invention provides an adhesive product, comprising the above pressure-sensitive adhesive. The adhesive product is then enabled to bond with other products through the above pressure-sensitive adhesive, or a plurality of members in the adhesive product are enabled to bond together through the above pressure-sensitive adhesive.

Specifically, the adhesive product may be any product including the above pressure-sensitive adhesive, such as labels, nameplates, stickers, billboards, covers and marks, so that it can be bonded to other products (such as construction, paper, cars and household appliances) by the above pressure-sensitive adhesive.

Preferably, the above adhesive product further comprises a second member bonded together with the first member through the above pressure-sensitive adhesive.

In short, a plurality of members in the adhesive product can be bonded together through the above pressure-sensitive adhesive. Therein, the pressure-sensitive adhesive may be a simple pressure-sensitive adhesive film, or a tape having a backing; the two members that are bonded together by the pressure-sensitive adhesive may sandwich the pressure-sensitive adhesive or the tape for direct bonding, or the two members may also be bonded to different locations of the tape for indirect bonding.

Specifically, the adhesive product may be a consumer electronic product or the like, such as a communication mobile terminal (mobile phone), a tablet computer and a notebook computer; correspondingly, the first member can be a support frame, and the second member can be a display screen (display panel) or a flexible circuit board or the like. The description above should not be construed as limiting the specific form of the adhesive product. Any products that include the above pressure-sensitive adhesive are all adhesive products.

### Specific Embodiments

The present invention is exemplarily illustrated by using different formulations and parameters to prepare different curable compositions, pressure-sensitive adhesives, and adhesive tapes as embodiments and comparative examples.

### 1. Materials

Materials actually used in various comparative examples and embodiments of the present invention are shown in the following table:

TABLE 1
Materials used in various embodiments

| | | Ingredients and relevant | |
|---|---|---|---|
| Name | Category | parameters | Purchase source |
| IOA (Isoocty Acrylate) | Non-tertiary alcohol | Isooctyl acrylate | 3M Company, Minnesota, |
| | (meth)acrylate monomer | | U.S.A. |
| 2-EHA (2-Ethylhexyl | Non-tertiary alcohol | 2-Ethylhexyl acrylate | Huayi Acrylic Acid Co. |
| Acrylate) | (meth)acrylate monomer | | Ltd., Shanghai City, China |
| BA (Butyl Acrylate) | Non-tertiary alcohol | Butyl acrylate | Huayi Acrylic Acid Co. |
| | (meth)acrylate monomer | | Ltd., Shanghai City, China |
| NNDMAA (N,N- | Non-acid functional and | N,N- | BRL Chemicals Co. Ltd., |
| Dimethylacrylamide) | ethylenically unsaturated | dimethylacrylamide | Beijing, China |
| | polar monomer | | |
| NVC (Vinylcaprolactam) | Non-acid functional and | N-vinyl caprolactam | BASF SE, Ludwigshafen, |
| | ethylenically unsaturated | | Germany |
| | polar monomer | | |
| IBxA (Isobornyl Acrylate) | High-Tg non-tertiary | Isobornyl acrylate | Osaka Organic Chemical |
| | alcohol (meth)acrylate | | Corporation, Osaka, Japan |
| | monomer | | |
| AA (Acrylic Acid) | Acid-functional non- | Acrylic acid | Huayi Acrylic Acid Co. |
| | ester unsaturated | | Ltd., Shanghai City, China |
| | monomer having at least | | |
| | one olefinic bond | | |
| IOTG (Iso-Octyl | Chain transfer agent | Isooctyl ethanethiol ester | Showa Denko K.K., |
| Thioglycolate) | | | Tokyo, Japan |
| HDDA (1,6-Hexanediol | Polyfunctional | 1,6-Hexanediol | Cytec Corporation, New |
| diacrylate) | (meth)acrylate cross- | diacrylate | Jersey, U.S.A. |
| | linking agent | | |
| TRIAZINE | Triazine cross-linking | 2,4-Bis | 3M Company, Minnesota, |
| | agent | (trichloromethyl)-6- | U.S.A. |
| | | (4-methoxyphenyl)- | |
| | | triazine | |
| Desmodur L75 | Isocyanate cross-linking | Isocyanate | Covestro Corporation, |
| | agent | | Leverkusen, Germany |
| Desmodur L1470 | Isocyanate cross-linking | Isocyanate | Covestro Corporation, |
| | agent | | Leverkusen, Germany |
| Desmodur VPLS2394 | Isocyanate cross-linking | Isocyanate | Covestro Corporation, |
| | agent | | Leverkusen, Germany |
| Desmodur N3300 | Isocyanate cross-linking | Isocyanate | Covestro Corporation, |
| | agent | | Leverkusen, Germany |
| IRGACURE 651 | Photoinitiator/additional | 2,2-dimethoxy-2-phenyl- | BSF Corporation, New |
| | photoinitiator | 1-acetophenone | Jersey, U.S.A. |
| REGRELTZ 6108 | Tackifying resin | Hydrocarbon resin-type | Eastman Chemical |
| | | tackifying resin | Corporation, Tennessee |
| | | | State, U.S.A. |
| FORAL 85LB | Tackifying resin | Hydrogenated rosin | Pinova Corporation, |
| | | tackifying resin | Georgia State, U.S.A. |
| UH115 | Tackifying resin | Hydrogenated terpene | Yasuhara Chemical |
| | | phenolic aldehyde | Corporation, Hiroshima, |
| | | tackifying resin | Japan |
| TH130 | Tackifying resin | Hydrogenated terpene | Yasuhara Chemical |
| | | phenolic aldehyde | Corporation, Hiroshima, |
| | | tackifying resin | Japan |
| TH150 | Tackifying resin | Hydrogenated terpene | Yasuhara Chemical |
| | | phenolic aldehyde | Corporation, Hiroshima, |
| | | tackifying resin | Japan |
| P90 | Tackifying resin | Hydrocarbon resin | Arakawa Chemical |
| | | | Industries, Ltd., Osaka, |
| | | | Japan |
| P125 | Tackifying resin | Hydrocarbon resin | Arakawa Chemical |
| | | | Industries, Ltd., Osaka, |
| | | | Japan |
| P140 | Tackifying resin | Hydrocarbon resin | Arakawa Chemical |
| | | | Industries, Ltd., Osaka, |
| | | | Japan |

Among the above raw materials, REGRELTZ 6108, FORAL 85LB, UH115, TH130, TH150, P90, P125 and P140 are known non-(meth)acrylate polymer tackifying resin products. Therein, the numbers in TH130, TH150 and P140 models indicate their softening point. Therefore, these three products belong to non-(meth)acrylate polymer tackifying resins with a softening point of greater than or equal to 130° C., while the other tackifying resins have a softening point of less than 130° C.

### 2. Test Method

Some tests are performed on curable compositions, pressure-sensitive adhesives, adhesive tapes and the like of various comparative examples and embodiments to determine their performance; the specific testing methods include:

### 1) Glass Transition Temperature (Tg) Test

The glass transition temperature (Tg) of the (meth)acrylate polymer tackifying resin was tested using a Q100 Differential Scanning calorimetry (DSC) instrument (TA Corporation, Delaware, U.S.A.). The test parameters thereof include:

Equilibrium starting temperature: −40° C.;
Equilibrium holding time: 2 mins;
Heating rate: 10° C./min;
Upper temperature: 40° C. or 100° C.;

In the test, neither temperature drop nor circulation is performed, and the glass transition temperature is calculated only with the endothermic peak during one-time temperature rise.

### 2) Monomer Conversion Test

The monomer conversion of the slurry polymer and the (meth)acrylate polymer tackifying resin (and the intermediate slurry polymer) is tested by a weight loss method, specifically including: weighing a given weight of the analyte into an aluminum plate, baking for 60±30 mins in a forced convection oven at 105±3° C. to evaporate the unpolymerized polymerizable monomer, remove the remainder and cooling for 5 mins followed by weighing, and calculating the monomer conversion according to the following formula:

Conversion %=100×(M1−M2)/M1;

where M1 is the total weight of the analyte before baking, M2 is the total weight of the analyte (remainder) after baking, and neither M1 nor M2 includes the weight of the aluminum plate.\

### 3) Test of Weight-Average Molecular Weight

The specific testing method of weight-average molecular weight includes: weighing 0.1 g of the sample into a 5 ml sample flask, and dissolving it by adding therein 3 ml of tetrahydrofuran (TEDIA Co., Ltd., Ohio State, U.S.A.); filtering the solution through a filter membrane with a pore diameter of 0.45 μm followed by addition the solution into a sample flask; and performing the test with a chromatography analyzer (Waters Corporation, Maryland State, U.S.A.), calibrating the resulting chromatographic column using standard polystyrene of a known weight-average molecular weight and establishing a calibration curve with the linear least squares analysis, to finally obtain the weight-average molecular weight.

### 4) Repulsion Resistance Test

The testing method for the repulsion resistance of the pressure-sensitive adhesive or tape is as follows:

The pressure-sensitive adhesive film or double-sided adhesive tape to be tested is cut into specimens of 10 mm wide, and 250 mm to 300 mm long;

The release film on one side of the specimen is removed, and the specimen is attached at the center of an anodized aluminum sheet and carefully pressed with a rubber roller to eliminate air bubbles between the bonding surfaces; wherein, the length direction of the specimen is parallel to the long side of the anodized aluminum sheet, and the size of the anodized aluminum sheet is 180 mm×20 mm×0.5 mm;

The excess portion of the specimen is cut off so that it is flush with the two short sides of the anodized aluminum sheet;

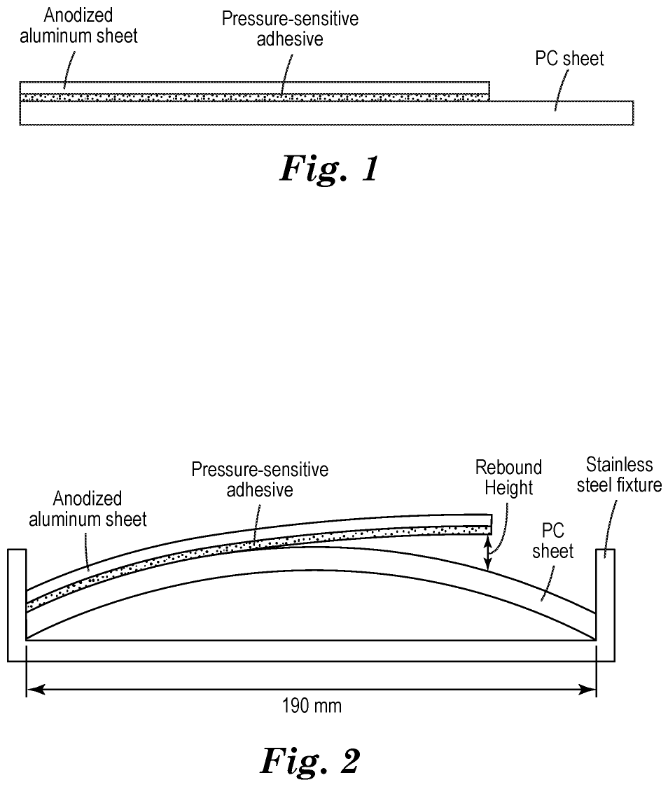

The release film on the other side of the specimen is removed, one short side of the anodized aluminum sheet is aligned with one short side of a polycarbonate PC (PC) sheet, the bonding spot is pressed by rolling a 2 kg rubber roller over it at a speed of 304.8 mm/min, and the anodized aluminum sheet is bonded to the PC sheet with the specimen; wherein the size of the PC sheet is 200 mm×30 mm×2 mm, which is larger than that of the anodized aluminum sheet, and thus the structure obtained at this time is as shown in FIG. 1;

The specimen to be tested is placed at a temperature of 23±2° C. and a relative humidity of 50±5% for 20 mins;

The specimen to be tested is carefully bent by hand with the anodized aluminum sheet kept on top and the PC sheet on the bottom, and placed in a stainless steel fixture with a length of 190 mm, so that the PC sheet is bent under force and the anodized aluminum sheet, which has been bonded to the specimen, is also bent with elastic deformation but has a tendency to recover from elastic deformation and come off from the PC sheet;

The stainless steel fixture and the specimen to be tested are immediately put into an oven at a temperature of 80° C. (condition A) or a damp heat aging tank at a temperature of 85° C. and a relative humidity of 85% (condition B) and the bonding condition of the anodized aluminum sheet on the PC sheet is observed on a regular basis; when failure occurs, i.e. the anodized aluminum sheet rebounds from the PC sheet as shown in FIG. 2, the time at which the failure occurred (time to failure) is recorded, and the rebound height is measured with a ruler; if the specimen does not rebound after 8 hours, the time to failure is recorded as “ND” and the rebound distance as “N/A”;

Finally, the rebound height of the specimen after 24 hours is recorded, and if failure has not occurred at this point, the rebound height after 24 hours is recorded as 0.

As can be seen, the above test results can reflect the repulsion resistance of pressure-sensitive adhesive or tape. The longer the time to failure and the lower the rebound height are, the better the repulsion resistance is.

In particular, the above conditions for the repulsion resistance test are very strict with a narrow specimen bonding area (10 mm), a short holding time before bending (20 mins), and a high test temperature (80° C. under condition A). Therefore, the specimen may be considered to have excellent repulsion resistance if it passes this test.

In particular, the temperature under condition B reaches 85° C. and the relative humidity is as high as 85%, resulting in a typical high-temperature and high-humidity environment, so the test results can well reflect the high-temperature and high-humidity repulsion resistance of the specimen.

It should be understood that, although other conventional properties such as the adhesive force of the pressure-sensitive adhesive are not tested in the present invention, since the pressure-sensitive adhesive can bond the anodized aluminum sheet to the PC sheet, its conventional properties such as adhesion and cohesive strength have definitely met the basic requirements.

### 3. Specific Preparation Method of Slurry Polymer

A slurry polymer is one of the components in a curable composition. In this invention, slurry polymers S1-S6 are first prepared according to the following method and used as raw materials of the curable composition. The specific preparation method of the slurry polymer includes the follows: monomers of the types and weights as listed in the following table are fed into a 1 quart glass jar; and a photoinitiator IRGACURE 651 is added therein in an amount of 0.04 parts by weight at this time based on 100 parts by weight of the polymerizable monomer for forming the slurry polymer (an additional portion of the photoinitiator is added directly into the curable composition later); nitrogen is charged into the raw material for 15 mins with magnetic stirring; and then the material is exposed to irradiation from a low-intensity UV source (with a wavelength of 365 nm, and an intensity of 1.5 milliwatts/square centimeter) and continuously testing its viscosity until the slurry polymers S1-S6 with a viscosity of 1500 centipoise to 7,000 centipoise (preferably 1,500 centipoise to 5,500 centipoise) at room temperature are obtained.

TABLE 2
Raw materials (all used in amounts of parts by
weight) and weight-average molecular weight
(Da) of polymerizable monomers of slurry polymer

| | | | | | | | weight-average |
|---|---|---|---|---|---|---|---|
| S/N | 2-EHA | IOA | NNDMAA | NVC | AA | IBxA | molecular weight |
| S1 | 82 | None | 7 | None | 3 | 8 | 2,723,000 |
| S2 | 84 | None | None | None | 4 | 12 | 4,192,000 |
| S3 | 86 | None | None | 6 | 2 | 6 | 1,213,000 |
| S4 | None | 90 | 6.5 | 3 | 0.5 | None | 2,028,000 |
| S5 | None | 90 | None | None | 10 | None | 7,306,000 |
| S6 | None | 94 | None | None | 6 | None | 5,283,000 |

Therein, for the comparability of results, the total amounts of monomer raw materials of each slurry polymer are all taken as 100 parts by weight; and slurry polymers selected in the subsequent embodiments and comparative examples are all prepared with 100 parts by weight of monomer raw materials; and the amounts of other substances used are all based on this standard.

As can be seen, in the above S5 and S6 slurry polymers, the content of the acid-functional non-ester unsaturated monomer having at least one olefinic bond (AA) is outside the preferred range.

### 4. Preparation of the (Meth)Acrylate Polymer Tackifying Resin

In this invention, (meth)acrylate polymer tackifying resins T1-T10 are first prepared according to the following method and used as raw materials of the curable composition. The specific preparation method of (meth)acrylate polymer tackifying resin includes the follows: monomers of the types and weights as listed in the following table, an additional photoinitiator IRGACURE 651, and a chain transfer agent IOTG are added into a 1 quart glass jar; the raw materials are purified with nitrogen gas for 15 mins under magnetic stirring, and then expose to the above-mentioned low-intensity UV light source with its viscosity continuously tested until an intermediate slurry polymer having appropriate monomer conversion is obtained; the intermediate slurry polymer is coated between two 0.05 mm thick CPFilmT10PET clear release films (Solutia, Missouri, U.S.A.), each coated with silicon on one side, with the coating thickness kept within the range of 0.1 mm to 0.3 mm, wherein PET stands for poly(ethylene terephthalate); then the product is exposed to the above low-intensity UV light for another about 10 mins to 20 mins until it is substantially completely cured (with monomer conversion greater than 99%), and the release film is removed to obtain the (meth)acrylate polymer tackifying resin.

TABLE 3
Raw materials of the (meth)acrylate polymer tackifying resin (in parts by
weight) and their respective properties

| | | | | | | | | Monomer | Monomer | | |
|---|---|---|---|---|---|---|---|---|---|---|---|
| | | | | | | | | conversion | conversion of | | weight- |
| | | | | | | | | of | (meth)acrylate | | average |
| | | | | | | | | intermediate | polymer | | molecular |
| | | | | | | | IRGACURE | slurry | tackifying | | weight |
| S/N | IOA | 2-EHA | BA | IBxA | AA | IOTG | 651 | polymer (%) | resin (%) | Tg (° C.) | (Da ) |
| T1 | None | None | None | 97 | 3 | 0.5 | 0.6 | 58.64 | 99.23 | 51.4 | 56580 |
| T2 | None | None | None | 97 | 3 | 0.8 | 0.6 | 55.16 | 99.48 | 48.3 | 44726 |
| T3 | None | None | None | 97 | 3 | 1 | 0.6 | 60.16 | 99.29 | 47.5 | 32085 |
| T4 | None | None | None | 97 | 3 | 1.4 | 1 | 62.77 | 99.35 | 46.1 | 22372 |
| T5 | None | None | None | 97 | 3 | 2 | 1 | 67.36 | 99.42 | 43.7 | 16639 |
| T6 | None | None | None | 97 | 3 | 5 | 1.2 | 42.73 | 99.09 | 39.2 | 7548 |
| T7 | None | None | 36 | 60 | 4 | 0.4 | 0.5 | 51.65 | 99.27 | 29.1 | 62568 |
| T8 | None | None | 36 | 60 | 4 | 1.5 | 0.8 | 49.28 | 99.47 | 22.3 | 21807 |
| T9 | None | None | 36 | 60 | 4 | 2.3 | 1 | 47.93 | 99.52 | 19.1 | 15171 |
| T10 | None | 49 | None | 48 | 3 | 0.8 | 0.6 | 52.05 | 99.15 | −13.2 | 34173 |

Therein, (meth)acrylate polymer tackifying resins T6 and T7 have weight-average molecular weights outside the range of 10,000 Da to 60,000 Da, and (meth)acrylate polymer tackifying resins T9 and T10 have glass transition temperatures of less than 20° C.

### 5. Embodiments and Comparative Examples

Curable compositions of various embodiments and comparative examples were prepared below according to different formulae and pressure-sensitive adhesives and adhesive tapes were formed for performance testing.

### 1) Comparative Examples C1-C3 and C1*-C3* and Embodiments 1-16 and 1*-16*

S1 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of comparative examples C1-C3 and embodiments 1-16 are formed.

At the same time, the curable compositions of comparative examples C1*-C3* and embodiments 1*-16* are prepared, wherein the ingredients of embodiments or comparative examples marked with “*” were substantially the same as embodiments or comparative examples not marked with “*,” except that 0.35 parts by weight of DesmodurL75 isocyanate cross-linking agent are further contained therein.

Meanwhile, the photoinitiator IRGACURE 651 in the table refers to the photoinitiator directly added to the curable composition, which, together with the photoinitiator added to the slurry polymer raw material, constitutes the photoinitiator component of the curable composition; however, this photoinitiator does not include the additional photoinitiator added to the (meth)acrylate polymer tackifying resin material, similarly hereinafter.

TABLE 4
Compositions of curable compositions of comparative examples C1-C3 and
embodiments 1-16 (amounts in parts by weight)

| | | | Type of | Amount | | | | | | | | |
|---|---|---|---|---|---|---|---|---|---|---|---|---|
| | | | (meth) | of (meth) | | | | | | | | |
| | | | acrylate | acrylate | | | | | | | | |
| | | | polymer | polymer | | | | | | | | |
| | | IRGACURE | tackifying | tackifying | | | | | | REGRELTZ | | FORAL |
| S/N | TRIAZINE | 651 | resins | resins | P140 | TH150 | TH130 | P125 | UH115 | 6108 | P90 | 85LB |
| C1 | 0.18 | 0.20 | T3 | 10 | 15 | None | None | None | None | None | None | None |
| C2 | 0.18 | 0.20 | T3 | 10 | 12 | None | None | None | None | None | None | None |
| C3 | 0.12 | 0.16 | T3 | 10 | 10 | None | None | None | None | None | None | None |
| 1 | 0.18 | 0.20 | T3 | 10 | 9 | None | None | None | 6 | None | None | None |
| 2 | 0.18 | 0.20 | T3 | 5 | 9 | None | None | None | 6 | None | None | None |
| 3 | 0.16 | 0.16 | T3 | 13 | 6 | None | None | None | 2 | None | None | None |
| 4 | 0.18 | 0.20 | T3 | 15 | 9 | None | None | None | 6 | None | None | None |
| 5 | 0.18 | 0.20 | T3 | 18 | 9 | None | None | None | 6 | None | None | None |
| 6 | 0.18 | 0.20 | T4 | 10 | 9 | None | None | None | 6 | None | None | None |
| 7 | 0.18 | 0.20 | T5 | 10 | 9 | None | None | None | 6 | None | None | None |
| 8 | 0.18 | 0.20 | T6 | 10 | 9 | None | None | None | 6 | None | None | None |
| 9 | 0.18 | 0.20 | None | None | 9 | None | None | None | 6 | None | None | None |
| 10 | 0.16 | 0.16 | T3 | 10 | None | 8 | None | None | 2 | None | None | None |
| 11 | 0.16 | 0.16 | T2 | 8 | 8 | None | None | 5 | None | None | None | None |
| 12 | 0.16 | 0.16 | T2 | 8 | None | None | None | 8 | 5 | None | None | None |
| 13 | 0.16 | 0.16 | T4 | 10 | 8 | None | None | None | None | 6 | None | None |
| 14 | 0.18 | 0.16 | T4 | 10 | 9 | None | None | None | None | None | None | 6 |
| 15 | 0.16 | 0.16 | T4 | 12 | 12 | None | None | None | None | None | 6 | None |
| 16 | 0.16 | 0.16 | T3 | 10 | None | None | 10 | None | 3 | None | None | None |

Each of the above curable compositions is coated between two 0.05 mm thick CP Film T10 PET clear release films (Solutia, Missouri, U.S.A.), with the adhesive film thickness kept at 0.05 mm, and exposed to the above low-intensity UV light for 5 mins to 10 mins for complete polymerization; specimens containing isocyanate cross-linking agents need to be left at 50° C. for another three days for maturating after the irradiation.

The release film on one side of the specimen is removed, and this side of the specimen is covered with a 0.1 mm thick layer of black polyethylene(PE) foam (Sekisui Chemical Co., Ltd., Osaka, Japan) after a double-sided corona treatment is performed on the PE foam with a Softal corona machine (Hamburg, Germany) before bonding so that the surface energy is greater than 52 dynes/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.2 mm is obtained.

Each specimen is left at a temperature of 23±2° C. and a relative humidity of 50±5% for one day and then subjected to a repulsion resistance test. The specific test results are shown in the following table.

TABLE 5
Repulsion resistance test results of comparative examples C1-C3 and C1*-
C3* and embodiments 1-16 and 1*-16*

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| C1 | 8 | 3 | 13 | 2 | 19 | 50 |
| C2 | 30 | 1 | 4 | 4 | 12 | 45 |
| C3 | 380 | 1 | 2 | 20 | 8 | 29 |
| 1 | ND | N/A | 0 | ND | N/A | 5 |
| 2 | ND | N/A | 1 | 105 | 2 | 6 |
| 3 | ND | N/A | 2 | 65 | 4 | 10 |
| 4 | ND | N/A | 1 | 90 | 2 | 7 |
| 5 | 450 | 2 | 5 | 48 | 5 | 20 |
| 6 | ND | N/A | 0 | ND | N/A | 6 |
| 7 | 420 | 1 | 3 | 35 | 7 | 25 |
| 8 | 270 | 3 | 8 | 12 | 12 | 28 |
| 9 | 420 | 1 | 4 | 45 | 7 | 23 |
| 10 | ND | N/A | 3 | 45 | 3 | 18 |
| 11 | ND | N/A | 0 | ND | N/A | 5 |
| 12 | 210 | 3 | 8 | 6 | 10 | 40 |
| 13 | ND | N/A | 3 | 36 | 4 | 18 |
| 14 | ND | N/A | 2 | 55 | 3 | 9 |
| 15 | ND | N/A | 0 | ND | N/A | 5 |
| 16 | ND | N/A | 3 | 40 | 4 | 19 |
| C1* | 210 | 2 | 6 | 25 | 15 | 35 |
| C2* | 320 | 2 | 4 | 75 | 10 | 29 |
| C3* | ND | N/A | 1 | 300 | 5 | 11 |
| 1* | ND | N/A | 0 | ND | N/A | 1 |
| 2* | ND | N/A | 0 | ND | N/A | 1 |
| 3* | ND | N/A | 0 | ND | N/A | 4 |
| 4* | ND | N/A | 0 | ND | N/A | 2 |
| 5* | ND | N/A | 1 | 340 | 3 | 6 |
| 6* | ND | N/A | 0 | ND | N/A | 1 |
| 7* | ND | N/A | 1 | 330 | 4 | 7 |
| 8* | ND | N/A | 2 | 210 | 6 | 15 |
| 9* | ND | N/A | 1 | 320 | 3 | 7 |
| 10* | ND | N/A | 0 | ND | 3 | 6 |
| 11* | ND | N/A | 0 | ND | N/A | 1 |
| 12* | 450 | 1 | 2 | 130 | 6 | 18 |
| 13* | ND | N/A | 0 | 360 | 3 | 5 |
| 14* | ND | N/A | 0 | 410 | 2 | 3 |
| 15* | ND | N/A | 0 | ND | N/A | 1 |
| 16* | ND | N/A | 0 | 370 | 3 | 6 |

As can be seen from the above table, the comparative examples with only one non-(meth)acrylate polymer tackifying resin have repulsion resistance that is significant less than the corresponding embodiment. This indicates that the repulsion resistance of the product can be remarkably improved by simultaneously using two non-(meth)acrylate polymer tackifying resins.

At the same time, the raw materials of some embodiments fail to meet the preferred requirements of the present invention, due to, for example, out-of-range molecular weight of the (meth)acrylate polymer tackifying resin (embodiment 8), absence of any (meth)acrylate polymer tackifying resin (embodiment 9), and absence of non-(meth)acrylate polymer tackifying resins with a softening point of a temperature greater than or equal to 130° C. (embodiment 12), etc., and the repulsion resistance of these embodiments is generally inferior to other embodiments. This indicates that the product properties can be further improved when the raw material components meet the preferred requirements of the present invention.

Further, for each embodiment not marked with “*,” the overall repulsion resistance at 80° C. (Condition A) is acceptable; however, when the temperature is raised to 85° C. and the relative humidity reaches 85% (Condition B), the high-temperature and high-humidity repulsion resistance is significantly reduced, and the rebound heights after 24 hours are at least 5 mm and basically all greater than 20 mm. This indicates that the high-temperature and high-humidity repulsion resistance of products without isocyanate crossing-link agents is unacceptable under Condition B, which is more severe. In contrast, the high-temperature and high-humidity repulsion resistance of each embodiment marked with “*” under Condition B is significantly higher than that of the corresponding embodiment not marked with “*,” and the rebound heights of many products after 24 hours are reduced to 1 mm and are mostly less than 10 mm.

This indicates that, by using both an isocyanate cross-linking agent and at least one non-isocyanate cross-linking agent in a specific curable composition system, the repulsion resistance (in particular, the high-temperature and high-humidity repulsion resistance at a temperature of 85° C. and a relative humidity of 85%) of the product may be further improved.

### 2) Embodiments 17-21

S1 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of embodiments 17-21 are formed.

TABLE 6
Compositions of curable compositions of embodiments
17-21 (amounts in parts by weight)

| SN | TRIAZINE | IRGACURE 651 | Desmodur L75 | T2 | P140 | P125 |
|---|---|---|---|---|---|---|
| 17 | 0.16 | 0.16 | 0.05 | 8 | 8 | 5 |
| 18 | 0.16 | 0.16 | 0.15 | 8 | 8 | 5 |
| 19 | 0.16 | 0.16 | 0.75 | 8 | 8 | 5 |
| 20 | 0.16 | 0.16 | 1.2 | 8 | 8 | 5 |
| 21 | 0.16 | 0.16 | 1.25 | 8 | 8 | 5 |

Each of the above curable compositions is coated between two 0.05 mm thick CP Film CP Film T10 PET clear release films (Solutia, Missouri, U.S.A.), with the adhesive film thickness kept at 0.05 mm, and exposed to the above low-intensity UV light for 5 mins to 10 mins for complete polymerization; specimens containing isocyanate cross-linking agents need to be left at 50° C. for another three days for maturating after the irradiation. The release film on one side of the specimen is removed, and this side of the specimen is covered with a 0.1 mm thick layer of black polyethylene(PE) foam (Sekisui Chemical Co., Ltd., Osaka, Japan), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.2 mm is obtained.

The double-sided tape is left at a temperature of 23±2° C. and a relative humidity of 50±5% for one day and then subjected to a repulsion resistance test. The specific test results are shown in the following table.

TABLE 7
Repulsion resistance test results of embodiments 17-21

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| 17 | ND | NA | 0 | ND | NA | 3 |
| 18 | ND | NA | 0 | ND | NA | 1 |
| 19 | ND | NA | 0 | ND | NA | 1 |
| 20 | ND | NA | 0 | ND | NA | 1 |

| | |
|---|---|
| 21 | Not testable |

As can be seen, most specimens containing isocyanate cross-linking agents exhibit excellent repulsion resistance under both Condition A and Condition B (which is more severe); and when the other components are the same, the high-temperature and high-humidity repulsion resistance under Condition B is further improved with the increase in the content of the isocyanate cross-linking agents.

However, for specimens with the amount of isocyanate cross-linking agents outside the preferred range (1.2%) (embodiment 21), the curable composition may be severely gelled, making it impossible to coat it as a layer or test its properties.

This indicates that, the use of isocyanate cross-linking agents may truly improve the repulsion resistance of the product (in particular the high-temperature and high-humidity repulsion resistance), but the amount of isocyanate cross-linking agents should not be as large as possible, and must be within the reasonable range required by the present invention.

### 3) Comparative Examples C4 and C4* and Embodiments 22-25 and 22*-25*

S2 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of comparative example C4 and embodiments 22-25 are formed.

At the same time, the curable compositions of comparative example C4* and embodiments 22*-25* are prepared, wherein the ingredients of embodiments or comparative examples marked with “*” were substantially the same as those of corresponding embodiments or comparative examples not marked with “*,” except that 0.55 parts by weight of DesmodurL75 isocyanate cross-linking agent are further contained therein.

TABLE 8
Compositions of curable compositions of comparative example C4 and
embodiments 22-25 (amounts in parts by weight)

| | | | Type of | Amount of | | | |
|---|---|---|---|---|---|---|---|
| | | | (meth)acrylate | (meth)acrylate | | | |
| | | IRGACURE | polymer | polymer | | | |
| S/N | TRIAZINE | 651 | tackifying resins | tackifying resins | TH150 | P140 | TH125 |
| C4 | 0.1 | 0.16 | T4 | 12 | None | 10 | None |
| 22 | 0.16 | 0.16 | T4 | 12 | 4 | 6 | None |
| 23 | 0.16 | 0.18 | T7 | 14 | None | 8 | 2 |
| 24 | 0.16 | 0.18 | T8 | 14 | None | 8 | 2 |
| 25 | 0.16 | 0.18 | T9 | 14 | None | 8 | 2 |

Each of the above curable compositions is coated between two 0.05 mm thick CP Film T10 PET clear release films (Solutia, Missouri, U.S.A.), with the adhesive film thickness kept at 0.075 mm, and exposed to the above low-intensity UV light for 5 mins to 10 mins for complete polymerization; specimens containing isocyanate cross-linking agents need to be left at 50° C. for another three days for maturating after the irradiation.

The release film on one side of the specimen is removed, and this side of the specimen is covered with a 0.15 mm thick layer of black polyethylene(PE) foam (Sekisui Chemical Co., Ltd., Osaka, Japan), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.3 mm is obtained.

The double-sided tape is left at a temperature of 23±2° C. and a relative humidity of 50±5% for one day and then subjected to a repulsion resistance test. The specific test results are shown in the following table.

TABLE 9
Repulsion resistance test results of comparative examples C4 and C4* and
embodiments 22-25 and 22*-25*

| | Condition A | | | Condition B | | |
|---|---|---|---|---|---|---|
| | Time to | Rebound height | Rebound height | | Rebound height | Rebound height |
| | failure | at time of failure | after 24 hours | Time to | at time of | after 24 hours |
| S/N | (min) | (mm) | (mm) | failure (min) | failure (mm) | (mm) |
| C4 | 7 | 3 | 18 | 2 | 21 | 49 |
| 22 | ND | NA | 0 | ND | NA | 4 |
| 23 | 380 | 1 | 3 | 25 | 9 | 31 |
| 24 | ND | NA | 6 | ND | NA | 5 |
| 25 | 325 | 2 | 0 | 18 | 11 | 36 |
| C4* | 230 | 3 | 6 | 7 | 3 | 18 |
| 22* | ND | N/A | 0 | ND | N/A | 1 |
| 23* | ND | N/A | 1 | 280 | 4 | 13 |
| 24* | ND | N/A | 0 | ND | N/A | 1 |
| 25* | ND | N/A | 1 | 225 | 5 | 16 |

The above experimental results also show that, the repulsion resistance of each of the embodiments is superior to the corresponding comparative example containing only one non-(meth)acrylate polymer tackifying resin; at the same time, the repulsion resistance (in particular the high-temperature and high-humidity repulsion resistance) of the respective embodiments and comparative examples is significantly improved after the addition of isocyanate cross-linking agents.

Further, in embodiments 23 and 23*, T7 (meth)acrylate polymer tackifying resin having a weight-average molecular weight outside the preferred range is used, and in embodiments 25 and 25*, T9 (meth) acrylate polymer tackifying resin having a glass transition temperature outside the preferred range is used. Therefore, their repulsion resistance is inferior to other embodiments.

This indicates that, the repulsion resistance (in particular, the high-temperature and high-humidity repulsion resistance) of the product may be further improved when the components are within the preferred range of the above requirements.

### 4) Comparative Examples C5 and C5* and Embodiments 26-27 and 26*-27*

S3 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of comparative example C5 and embodiments 26-27 are formed.

At the same time, the curable compositions of comparative example C5* and embodiments 26*-27* are prepared, wherein the ingredients of embodiments or comparative examples marked with “*” were substantially the same as those of corresponding embodiments or comparative examples not marked with “*,” except that 0.1 parts by weight of DesmodurL75 isocyanate cross-linking agent are further contained therein.

TABLE 10
Compositions of curable compositions of comparative example C5 and
embodiments 26-27 (amounts in parts by weight)

| | | | | Type of | Amount of | | |
|---|---|---|---|---|---|---|---|
| | | | | (meth)acrylate | (meth)acrylate | | |
| | | | IRGACURE | polymer | polymer | | |
| S/N | TRIAZINE | HDDA | 651 | tackifying resins | tackifying resins | P140 | TH130 |
| C5 | 0.08 | 0.05 | 0.2 | T2 | 10 | 16 | None |
| 26 | 0.08 | 0.05 | 0.18 | T2 | 10 | 9 | 7 |
| 27 | 0.08 | 0.05 | 0.18 | T10 | 10 | 9 | 7 |

Each of the above curable compositions is coated between two 0.05 mm thick CP Film T10 PET clear release films (Solutia, Missouri, USA), with the adhesive film thickness kept at 0.1 mm, and exposed to the above low-intensity UV light for 5 mins to 10 mins for complete polymerization; specimens containing isocyanate cross-linking agents need to be left at 50° C. for another three days for maturating after the irradiation.

The release film on one side of the specimen is removed, and this side of the specimen is covered with a 0.2 mm thick layer of black PE foam (Hubei Xiangyuan New Material Technology Co., Ltd., Xiaogan, Hubei, China), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.4 mm is obtained.

The double-sided tape is left at a temperature of 23±2° C. and a relative humidity of 50±5% for one day and then subjected to a repulsion resistance test. The specific test results are shown in the following table.

TABLE 11
Repulsion resistance test results of comparative
examples C5 and C5* and embodiments 26-27 and 26*-27*

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| C5 | 12 | 5 | 21 | 2 | 21 | 49 |
| 26 | ND | N/A | 1 | 280 | 1 | 4 |
| 27 | 4 | 16 | 35 | 1 | 45 | 50 |
| C5* | 255 | 3 | 6 | 30 | 10 | 23 |
| 26* | ND | N/A | 0 | ND | N/A | 1 |
| 27* | 175 | 4 | 9 | 12 | 14 | 36 |

The above experimental results also show that, in the case where a multifunctional (meth)acrylate cross-linking agent is also used, the repulsion resistance of each of the embodiments is superior to the corresponding comparative example containing only one non-(meth)acrylate polymer tackifying resin; at the same time, the repulsion resistance (in particular the high-temperature and high-humidity repulsion resistance) of the respective embodiments and comparative examples is significantly improved after the addition of isocyanate cross-linking agents.

### 5) Comparative Examples C6 and C6* and Embodiments 28 and 28*

S4 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of comparative example C6 and embodiment 28 are formed.

At the same time, the curable compositions of comparative example C6* and embodiment 28* are prepared, wherein the ingredients of embodiments or comparative examples marked with “*” were substantially the same as those of corresponding embodiments or comparative examples not marked with “*,” except that 1 part by weight of DesmodurL75 isocyanate cross-linking agent is further contained therein.

TABLE 12
Compositions of curable compositions of comparative example C6 and
embodiment 28 (amounts in parts by weight)

| | | | Type of (meth)acrylate | Amount of | | |
|---|---|---|---|---|---|---|
| | | IRGACURE | polymer tackifying | (meth)acrylate polymer | | |
| S/N | TRIAZINE | 651 | resins | tackifying resins | P140 | TH130 |
| C6 | 0.16 | 0.2 | T2 | 9 | 10 | None |
| 28 | 0.16 | 0.2 | T2 | 9 | 7 | 3 |

Each of the above curable compositions is coated between two 0.05 mm thick CP Film T10 PET clear release films (Solutia, Missouri, U.S.A.), with the adhesive film thickness kept at 0.025 mm, and exposed to the above low-intensity UV light for 5 mins to 10 mins for complete polymerization; specimens containing isocyanate cross-linking agents need to be left at 50° C. for another three days for maturating after the irradiation. The release film on one side of the specimen is removed, and this side of the specimen is covered with a 0.1 mm thick layer of black polyethylene(PE) foam (Sekisui Chemical Co., Ltd., Osaka, Japan), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.15 mm is obtained.

The double-sided tape is left at a temperature of 23±2° C. and a relative humidity of 50±5% for one day and then subjected to a repulsion resistance test. The specific test results are shown in the following table.

TABLE 13
Repulsion resistance test results of comparative examples C6 and C6* and
embodiments 28 and 28*

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| C6 | 190 | 4 | 8 | 4 | 12 | 45 |
| 28 | ND | N/A | 3 | 35 | 5 | 20 |
| C6* | 410 | 2 | 4 | 95 | 11 | 21 |
| 28* | ND | N/A | 0 | ND | N/A | 1 |

The above experimental results also show that, the repulsion resistance of each of the embodiments is superior to the corresponding comparative example containing only one non-(meth)acrylate polymer tackifying resin; at the same time, the repulsion resistance (in particular the high-temperature and high-humidity repulsion resistance) of the respective embodiments and comparative examples is significantly improved after the addition of isocyanate cross-linking agents.

### 6) Embodiments 29-32 and 29*-32*

S5 or S6 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of embodiments 29-32 are formed.

At the same time, the curable compositions of embodiments 29*-32* are prepared, wherein the ingredients of embodiments or comparative examples marked with “*” were substantially the same as those of corresponding embodiments or comparative examples not marked with “*,” except that 0.65 parts by weight (for embodiments 29 and 30) or 0.25 parts by weight (for embodiments 31 and 32) of DesmodurL75 isocyanate cross-linking agent are further contained therein.

TABLE 14
Compositions of curable compositions of embodiments
29-32 (amounts in parts by weight)

| | | | | Type of | Amount of | | |
|---|---|---|---|---|---|---|---|
| | Type of | | | (meth)acrylate | (meth)acrylate | | |
| | slurry | | IRGACURE | polymer | polymer | | |
| S/N | polymer | TRIAZINE | 651 | tackifying resins | tackifying resins | P140 | P90 |
| 29 | S5 | 0.18 | 0.18 | T3 | 10 | 8 | 6 |
| 30 | S5 | 0.2 | 0.18 | T3 | 10 | 10 | 6 |
| 31 | S6 | 0.18 | 0.18 | T3 | 10 | 8 | 6 |
| 32 | S6 | 0.2 | 0.18 | T3 | 10 | 10 | 6 |

Each of the above curable compositions is coated between two 0.05 mm thick CP Film T10 PET clear release films (Solutia, Missouri, U.S.A.), with the adhesive film thickness kept at 0.05 mm, and exposed to the above low-intensity UV light for 5 mins to 10 mins for complete polymerization; specimens containing isocyanate cross-linking agents need to be left at 50° C. for another three days for maturating after the irradiation.

The release film on one side of the specimen is removed, and this side of the specimen is covered with a 0.1 mm thick layer of black polyethylene(PE) foam (Sekisui Chemical Co., Ltd., Osaka, Japan), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.2 mm is obtained.

The double-sided tape is left at a temperature of 23±2° C. and a relative humidity of 50±5% for one day and then subjected to a repulsion resistance test. The specific test results are shown in the following table.

TABLE 15
Repulsion resistance test results of embodiments 29-32 and 29*-32*

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| 29 | 2 | 28 | 39 | 1 | 46 | 55 |
| 30 | 3 | 20 | 32 | 1 | 47 | 55 |
| 31 | 2 | 30 | 38 | 1 | 46 | 55 |
| 32 | 2 | 29 | 40 | 1 | 46 | 55 |
| 29* | 95 | 12 | 19 | 7 | 18 | 39 |
| 30* | 75 | 15 | 21 | 8 | 19 | 41 |
| 31* | 95 | 11 | 18 | 6 | 17 | 37 |
| 32* | 100 | 11 | 17 | 7 | 18 | 38 |

As can be seen, in the S5 and S6 slurry polymers used in the above embodiments, the content of the acid-functional non-ester unsaturated monomer having at least one olefinic bond (AA) is outside the preferred range. Therefore, the times to failure of the products of these embodiments are all very short. However, it can also be seen from these embodiments that, by adding isocyanate cross-linking agents, the repulsion resistance of the product (in particular the high-temperature and high-humidity repulsion resistance) may still be improved.

### 7) Embodiments 33-35

S4 slurry polymer formed of 100 parts by weight of the polymerizable monomer is added into a 1 quart glass jar; then other raw materials are added therein according to the following table; and the mixture is stirred while being protected from light until uniform dissolution; and the curable compositions of embodiments 33-35 are formed.

TABLE 16
Compositions of curable compositions of embodiments 33-35
(amounts in parts by weight)

| | | Type of | Amount of | | | | | |
|---|---|---|---|---|---|---|---|---|
| | | isocyanate | isocyanate | | | Amount of | | |
| | | cross- | cross- | | Type of (meth) | (meth) acrylate | | |
| | | linking | linking | IRGACURE | acrylate polymer | polymer | | |
| S/N | TRIAZINE | agent | agent | 651 | tackifying resins | tackifying resins | P140 | TH130 |
| 33 | 0.16 | Desmodur | 1 | 0.2 | T2 | 9 | 7 | 3 |
| | | L1470 | | | | | | |
| 34 | 0.16 | Desmodur | 1 | 0.2 | T2 | 10 | 7 | 3 |
| | | VPLS2394 | | | | | | |
| 35 | 0.16 | Desmodur | 1 | 0.2 | T2 | 9 | 7 | 3 |
| | | N3300 | | | | | | |

Each of the above curable compositions is coated between two 0.05 mm thick CP Film T10 PET clear release films (Solutia, Missouri, U.S.A.), with the adhesive film thickness kept at 0.025 mm, exposed to the above low-intensity UV light for 5 mins to 10 mins for complete polymerization, and left at 50° C. for another three days for maturating after the irradiation.

The release film on one side of the specimen is removed, and this side of the specimen is covered with a 0.1 mm thick layer of black polyethylene(PE) foam (Sekisui Chemical Co., Ltd., Osaka, Japan), after a double-sided corona treatment is performed on the PE foam with a Softal corona machine (Hamburg, Germany) before bonding so that the surface energy is greater than 52 dyns/cm; the uncovered surface of the PE foam is covered with another layer of the above adhesive film (also with the release film removed on one side), and is manually pressed with a 2 kg rubber roller to ensure that the adhesive film and the PE foam are completely bonded together; thus a double-sided tape backed by PE foam with a total thickness of 0.15 mm is obtained.

The double-sided tape is left at a temperature of 23±2° C. and a relative humidity of 50±5% for one day and then subjected to a repulsion resistance test. The specific test results are shown in the following table.

TABLE 17
Repulsion resistance test results of embodiments 33-35

| | Condition A | | | Condition B | | |
|---|---|---|---|---|---|---|
| | | Rebound height | Rebound height | | Rebound height | Rebound height |
| | Time to | at time of | after 24 hours | Time to | at time of | after 24 hours |
| S/N | failure (min) | failure (mm) | (mm) | failure (min) | failure (mm) | (mm) |
| 33 | ND | N/A | 0 | ND | N/A | 1 |
| 34 | ND | N/A | 0 | ND | N/A | 1 |
| 35 | ND | N/A | 0 | ND | N/A | 1 |

As can be seen, products containing other types of isocyanate cross-linking agents other than the Desmodur L75 isocyanate cross-linking agent also have very excellent repulsion resistance (in particular the high-temperature and high-humidity repulsion resistance).

### CONCLUSIONS

It can be concluded from the above respective comparative examples and embodiments that, by using both isocyanate cross-linking agents and non-isocyanate cross-linking agents in a specific curable composition, the repulsion resistance (in particular, the high-temperature and high-humidity repulsion resistance at a temperature of 85° C. and a relative humidity of 85%) of the pressure-sensitive adhesive formed thereof may be excellent; wherein the above curable composition should meet the following conditions:

(1) Containing a specific (meth)acrylate monomer and a non-ester unsaturated monomer;
(2) Containing a (meth)acrylate polymer tackifying resin having a specific glass transition temperature and a specific molecular weight;
(3) Containing at least two non-(meth)acrylate polymer tackifying resin, wherein at least a portion of the non-(meth)acrylate polymer tackifying resin has a specific softening point.

Further, when the content of isocyanate cross-linking agents, the content of each tackifying resin, and the proportion of the non-(meth)acrylate polymer tackifying resin having a specific softening point are within the preferred range, the repulsion resistance (in particular, the high-temperature and high-humidity repulsion resistance at a temperature of 85° C. and a relative humidity of 85%) of the product may be further improved.

It can be understood that, the above embodiments are only exemplary embodiments employed for illustration of principles of the present invention, and do not limit the present invention. For those of ordinary skill in the art, various variations and modifications may be made without departing from the spirit and essence of the present invention, which variations and modifications are also considered as falling within the protection scope of the present invention.

1. A curable composition, comprising:
a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin, having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of the non-(meth)acrylate polymer tackifying resins has a softening point greater than or equal to 130° C.;
a cross-linking agent component, comprising an isocyanate cross-linking agent and at least one non-isocyanate cross-linking agent.

2. The curable composition according to claim 1, wherein
the isocyanate cross-linking agent is a non-blocked isocyanate cross-linking agent.

3. The curable composition according to claim 1, wherein
the non-isocyanate cross-linking agent is a non-thermosensitive non-isocyanate cross-linking agent.

4. The curable composition according to claim 1, wherein
the non-isocyanate cross-linking agent comprises one or more of triazine cross-linking agents, multifunctional (meth)acrylate cross-linking agents, benzophenone cross-linking agents, and copolymerizable aromatic ketone cross-linking agents.

5. The curable composition according to claim 1, wherein the non-(meth)acrylate polymer tackifying resin component comprises at least two tackifying resins respectively selected from the following different types of resins:
hydrogenated rosin resin-type tackifying resins, hydrogenated terpene phenolic resin-type tackifying resins, and hydrocarbon resin-type tackifying resins.

6. The curable composition according to claim 1, wherein
the (meth)acrylate polymer tackifying resin is formed via copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond.

7. The curable composition according to claim 1, further comprising:
a photoinitiator.

8. The curable composition according to claim 1, further comprising:
a (meth)acrylate copolymer, formed via copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond; and
the (meth)acrylate copolymer has a weight-average molecular weight of between 500,000 Da and 10,000,000 Da.

9. The curable composition according to claim 8, wherein
a weight ratio of the isocyanate cross-linking agent to a total weight of the monomer component and the polymerizable monomers for forming the (meth)acrylate copolymer is less than or equal to 1.2%; and
a weight ratio of the non-isocyanate cross-linking agent to a total weight of the monomer component and the polymerizable monomers for forming the (meth)acrylate copolymer is less than or equal to 5%.

10. The curable composition according to claim 9, wherein
a weight ratio of the isocyanate cross-linking agent to a total weight of the monomer component and the polymerizable monomers for forming the (meth)acrylate copolymer is between 0.1% and 1.2%; and
a weight ratio of the non-isocyanate cross-linking agent to a total weight of the monomer component and the polymerizable monomers for forming the (meth)acrylate copolymer is between 0.01% and 2%.

11. The curable composition according to claim 8, wherein
a weight ratio of the (meth)acrylate polymer tackifying resin to a total weight of the monomer component and the polymerizable monomers for forming the (meth)acrylate copolymer is between 5% and 18%; and
a weight ratio of the non-(meth)acrylate polymer tackifying resin component to a total weight of the monomer component and the polymerizable monomers for forming the (meth)acrylate copolymer is between 8% and 18%.

12. The curable composition according to claim 8, wherein
a weight ratio of the non-(meth)acrylate polymer tackifying resins, having a softening point greater than or equal to 130° C. in the non-(meth)acrylate polymer tackifying resin component, to a total weight of the monomer component and the polymerizable monomers for forming the (meth)acrylate copolymer is greater than or equal to 6%.

13. The curable composition according to claim 8, wherein
a slurry polymer is formed with the monomer component and the (meth)acrylate copolymer; and
the slurry polymer is formed via partial copolymerization of raw materials comprising at least two polymerizable monomers, wherein the polymerizable monomers comprise a non-tertiary alcohol (meth)acrylate monomer, and an acid-functional non-ester unsaturated monomer having at least one olefinic bond.

14. A pressure-sensitive adhesive formed by curing a curable composition, wherein the curable composition comprises:
a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

15. An adhesive tape, comprising a pressure-sensitive adhesive formed by curing a curable composition, wherein the curable composition comprises:
a monomer component, comprising at least two polymerizable monomers, wherein the polymerizable monomers comprise a non-tertiary alcohol (meth)acrylate monomer, and an acid-functional non-ester unsaturated monomer having at least one olefinic bond;
a (meth)acrylate polymer tackifying resin having a weight-average molecular weight of between 10,000 Da and 60,000 Da and a glass transition temperature greater than or equal to 20° C.;
a non-(meth)acrylate polymer tackifying resin component, comprising at least two non-(meth)acrylate polymer tackifying resins, wherein at least a part of non-(meth)acrylate polymer tackifying resins has a softening point greater than or equal to 130° C.;
a cross-linking agent component, comprising an isocyanate cross-linking agent and at least one non-isocyanate cross-linking agent.

16. An adhesive product, comprising a first member, wherein at least a partial surface of the first member has a pressure-sensitive adhesive bonded thereon, and the pressure-sensitive adhesive is formed by curing the curable composition according to claim 1.
